(19) United States
(12) Patent Application Publication
(10) Pub. No.: US 2024/0331323 A1
(43) Pub. Date: Oct. 3, 2024

(54) SYSTEMS, METHODS, AND COMPUTER-READABLE MEDIA FOR 3D ASSET COMPILER

(71) Applicant: Brenden Michael Dearie, Phoenix, AZ (US)

(72) Inventor: Brenden Michael Dearie, Phoenix, AZ (US)

(21) Appl. No.: 18/466,729

(22) Filed: Sep. 13, 2023

Related U.S. Application Data
(63) Continuation-in-part of application No. 18/191,799, filed on Mar. 28, 2023.

(51) Int. Cl. G06T 19/20; B33Y 50/00; G06F 3/04815; G06F 3/0482; G06T 9/00; G06T 17/00

(52) U.S. Cl. CPC G06T 19/20; B33Y 50/00; G06F 3/04815; G06F 3/0482; G06T 9/001; G06T 17/00; G06T 2200/24; G06T 2210/16; G06T 2219/2008

(57) ABSTRACT

This disclosure is directed to 3D asset compilers, including related systems, methods, computer-readable media, and computer program products. Some embodiments may include circuitry configured for or a method comprising hosting or running a three-dimensional (3D) asset compiler coded to present a graphical user interface (GUI) on a display of a user interface. Functionality of the 3D asset compiler may be accessible via the GUI and may include presenting a plurality of 3D digital assets, accessible to be selected by a user via the GUI, and compiling or combining together two or more 3D digital assets, selected by the user via the GUI into a compiled or combined 3D object. Non-transitory computer-readable storage may store the 3D object when compiled or combined together from the selected two or more 3D digital assets. The stored 3D object may be rendered for display on the display of the user interface.

### CROSS-REFERENCE TO RELATED APPLICATIONS

This application is a continuation-in-part of U.S. patent application Ser. No. 18/191,799, filed on Mar. 28, 2023, the contents of which are incorporated by reference in their entirety for all purposes.

### FIELD OF THE INVENTION

This disclosure generally relates to three-dimensional (3D) asset compilers. More specifically, this disclosure generally relates to methods, systems, computer-readable media, and computer program products relating to 3D asset compilers.

### BACKGROUND

There are many digital environments, such as video games and digital 3D experience platforms, online or standalone. Each digital environment can be like its own digital world, and some digital environments may allow a user to own or have or control some personal digital assets in that respective digital world. However, these digital worlds are separate and distinct in that they cannot connect to each other. Thus, users by default understand and assume that digital assets in one digital environment is dedicated to that digital environment and not exportable to another different digital environment. For example, when a user handles digital assets such as clothing, a weapon, a tool, or a vehicle in a first video game, such digital assets are not designed to ever be exportable to a second different video game.

Additionally, within a digital environment such as a 3D video game, a conventional digital asset may be merely a 2D pattern that can be overlaid on a 3D object, but the digital asset itself is not a 3D digital asset. For example, a 3D video game may have a base 3D avatar that a user can modify via different 2D-patterned or 3D-overlaid skins. The skin itself is not a 3D object, but rather a 2D pattern or a 3D overlay that is to be overlaid on the exterior of the base 3D avatar, appearing like the skin on the avatar.

Distributed ledger technology, such as blockchain, can provide a variety of features including scarcity of digital assets, such as digital assets authenticated—and typically made scarce—by non-fungible tokens (NFTs). NFTs may commonly be linked to digital art images or short digital video clips, and users may manage their ownership of such NFT-authenticated images or videos through digital wallets, e.g., blockchain “wallets”. Digital wallets, however, are limited to a mere listing of a single owner's digital assets. For ease of reference in this disclosure, an NFT-authenticated digital asset may be referenced as an “NFT asset,” e.g., an “NFT image”, “NFT video”, “NFT artwork”, “NFT video game equipment”.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

This disclosure is directed to 3D asset compilers, including systems, methods, and computer-readable media for 3D compilers. Some system embodiments may include a system comprising: circuitry configured for: hosting or running a three-dimensional (3D) asset compiler coded to present a graphical user interface (GUI) on a display of a user interface, wherein: functionality of the 3D asset compiler is accessible via the GUI to be displayed on the display of the user interface, and the functionality of the 3D asset compiler includes: presenting a plurality of 3D digital assets to be displayed on the display of the user interface, the presented plurality of 3D digital assets accessible to be selected by a user via the GUI, and compiling or combining together two or more 3D digital assets selected from among the presented plurality of 3D digital assets, the two or more 3D digital assets selected by the user via the GUI into a compiled or combined 3D object; and non-transitory computer-readable storage configured for storing the 3D object when compiled or combined together from the selected two or more 3D digital assets, wherein the stored 3D object is to be rendered for display on the display of the user interface.

Some computer-readable medium embodiments may include a non-transitory computer-readable medium storing instructions, such that when the instructions are executed by one or more processors, the one or more processors are configured to perform a method comprising: hosting or running a three-dimensional (3D) asset compiler coded to present a graphical user interface (GUI) on a display of a user interface, wherein: functionality of the 3D asset compiler is accessible via the GUI to be displayed on the display of the user interface, and the functionality of the 3D asset compiler includes: presenting a plurality of 3D digital assets to be displayed on the display of the user interface, the presented plurality of 3D digital assets accessible to be selected by a user via the GUI, and compiling or combining together two or more 3D digital assets selected from among the presented plurality of 3D digital assets, the two or more 3D digital assets selected by the user via the GUI into a compiled or combined 3D object, wherein a non-transitory computer-readable storage stores the 3D object when compiled or combined together from the selected two or more 3D digital assets, wherein the stored 3D object is to be rendered for display on the display of the user interface.

In some embodiments, the circuitry is further configured for or the method further comprises: importing the plurality of 3D digital assets to be presented by the 3D asset compiler; and outputting an output 3D file comprising at least part of the 3D object; and the non-transitory computer-readable storage stores the imported plurality of 3D digital assets to be presented by the 3D asset compiler and stores the output 3D file comprising the at least part of the 3D object. In some embodiments, the imported plurality of 3D digital assets to be presented by the 3D asset compiler are working copy files or datasets of original copy files or datasets of the plurality of 3D digital assets, and the output 3D file comprises at least one working copy file or dataset of at least part of the 3D object.

In some embodiments, the circuitry is further configured for or the method further comprises: generating an output 3D file comprising the 3D object, wherein the generating comprises performing optimization or compression so that the output 3D file is smaller in size than a total sum of the 3D digital assets selected to be compiled or combined into the 3D object; and the non-transitory computer-readable storage stores the output 3D file comprising the 3D object.

In some embodiments, the circuitry is further configured for or the method further comprises: receiving an input text prompt or an input image for use by an artificial intelligence (AI) or machine learning (ML) function; and generating at least one of the plurality of 3D digital assets to be presented by the 3D asset compiler, wherein the generating comprises performing the artificial intelligence (AI) or machine learning (ML) function based on the input text prompt or the input image; and the non-transitory computer-readable storage stores the at least one generated 3D digital asset.

In some embodiments, the circuitry is further configured for or the method further comprises: implementing an Application Programming Interface (API) accessible by a 3D experience platform; receiving one or more API calls from the 3D experience platform, calling for the 3D object to be conveyed to the 3D experience platform; and conveying the 3D object to the 3D experience platform.

In some embodiments, the circuitry is further configured for or the method further comprises: the circuitry is further configured for: outputting an output 3D file comprising at least part of the 3D object, the output 3D file compatible or belonging to a 3D-printing file type or file format; and sending instructions to a 3D printer to 3D-print the at least part of the 3D object based on the output 3D file; and the non-transitory computer-readable storage stores the output 3D file comprising at least part of the 3D object.

In some embodiments, the circuitry is further configured for or the method further comprises: receiving one or more scans of a physical object; generating, based on the one or more scans, a 3D model as one of the plurality of 3D digital assets to be presented by the 3D asset compiler, the 3D model to be compiled or combined together with another 3D digital asset selected from among the presented plurality of 3D digital assets, the another 3D digital asset selected by the user via the GUI for inclusion in the compiled or combined 3D object; outputting an output 3D file comprising the another 3D digital asset, the output 3D file comprising a design or instructions for manufacturing the another 3D digital asset into a physical product; and sending instructions to a fabrication machine or facility to manufacture the another 3D digital asset into the physical product based on the output 3D file; and the non-transitory computer-readable storage stores the output 3D file comprising the design or instructions for manufacturing the another 3D digital asset into the physical product. In some embodiments, the physical object is a human body, the one or more scans of the physical object comprise representations of one or more body parts of the physical object, the 3D model generated based on the one or more scans has one or more actual size measurements or proportions of the scanned human body, and the physical product comprises one or more pieces of clothing wearable by the physical object and based on the one or more actual size measurements or proportions of the scanned human body.

In some embodiments, the circuitry is further configured for or the method further comprises: the circuitry is further configured for: outputting an output 3D file comprising at least part of the 3D object, the output 3D file comprising a file type that is compatible with 3D hologram projection; and sending instructions to a 3D hologram projector to project the at least part of the 3D object as a holographic projection based on the output 3D file; and the non-transitory computer-readable storage stores the output 3D file comprising at least part of the 3D object.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification.

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. In the drawings:

FIG. 1 illustrates an example screen layout of a graphical user interface for a 3D asset compiler.

FIG. 2 illustrates an exemplary embodiment of a system operating a 3D asset compiler.

FIG. 3 illustrates an output 3D file from a 3D asset compiler and example uses of the 3D file.

FIG. 4 illustrates an example screen layout of a graphical user interface for a 3D asset compiler.

FIG. 5 illustrates an example screen layout of a graphical user interface for a 3D asset compiler.

FIG. 6A illustrates example processes for 3D file generation and 3D model production.

FIG. 6B illustrates example file optimization and/or compression and unpackaging with a 3D asset compiler(s).

FIG. 7 illustrates an output 3D file from a 3D asset compiler where the 3D file is usable for 3D printing.

FIG. 8 illustrates an example system where a user can encounter a geolocated event where a 3D asset compiler can be used with 3D printing.

FIG. 9 illustrates an output 3D file from a 3D asset compiler and another use of the 3D file.

FIG. 10 illustrates an example system where a user can scan a physical object and use a 3D asset compiler with 3D printing to make objects based on that scanning.

FIG. 11 illustrates an output 3D file from a 3D asset compiler where the 3D file is usable for 3D hologram projection.

FIG. 12 illustrates an example of trait sorting for a modular design of an avatar for use with a 3D asset compiler.

FIG. 13 is a circuit diagram of one aspect of a computing device that works in conjunction with the elements of the present disclosure.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

This disclosure is not limited to the particular systems, devices and method described, as these may vary. The terminology used in the description is for the purpose of describing the particular versions or embodiments only, and is not intended to limit the scope. Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Descriptions of well-known starting materials, processing techniques, components and equipment may be omitted so as not to unnecessarily obscure the invention in detail. It should be understood, however, that the detailed description and the specific examples, while indicating (e.g., preferred) embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer-readable medium (e.g., a hard disk drive, flash drive or other memory), hardware circuitry or the like, or any combination.

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.) or the like. In various embodiments, the computer has access to at least one database over the network.

ROM, RAM, and HD are computer memories for storing data and computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

The following terms shall have, for the purposes of this application, the respective meanings set forth below.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, and/or consumers. For example, a user can be an administrator, a developer, a group of individuals, a content provider, a consumer, a representative of another entity described herein, and/or the like.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions, mobile devices, medical devices, recording devices, and/or the like.

A “mobile device” refers to an electronic device that is generally portable in size and nature or is capable of being operated while in transport. Accordingly, a user may transport a mobile device with relative ease. Examples of mobile devices include cellular phones, feature phones, smartphones, smartwatches, wearable computers or interfaces thereof, personal digital assistants (PDAs), cameras, tablet computers, laptop computers, netbooks, global positioning satellite (GPS) navigation devices, in-dash automotive components, media players, watches, and the like.

A “computing device” is an electronic device, such as a computer including a processor, a memory, and/or any other component, device or system that performs one or more operations according to one or more programming instructions. A computing device may be a mobile device.

A “user interface” is an interface which allows a user to interact with an electronic device, a mobile device, or a computing device. A user interface may generally provide information or data to the user and/or receive information or data from the user. The user interface may enable input from a user to be received by the device and may provide output to the user from the device. Accordingly, the user interface may allow a user to control or manipulate a device and may allow the device to indicate the effects of the user's control or manipulation. The display of data or information on a display or a graphical user interface is a non-limiting example of providing information to a user. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are non-limiting examples of user interface components which enable the receiving of information or data from a user. A user interface may arbitrate and include communication between a user and an electronic device 1000. For example, the user interface may include input interfaces such as a keypad, a button, a touch screen, a touch pad, a gyroscope sensor, a vibration sensor, and an acceleration sensor.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

Although the figures and the descriptions described herein may be referred to using language such as “one embodiment,” or “certain embodiments,” or “example embodiments,” or “at least one embodiment” etc., these figures, and their corresponding descriptions are not intended to be mutually exclusive from other figures and/or descriptions, unless the context so indicates. Therefore, certain aspects from certain figures may be the same as certain features in other figures, and/or certain figures may be different representations or different portions of a particular exemplary embodiment, and/or certain aspects may be used with other aspects even if not explicitly mentioned, etc. Furthermore, any feature disclosed in one embodiment may be useable in any other embodiment.

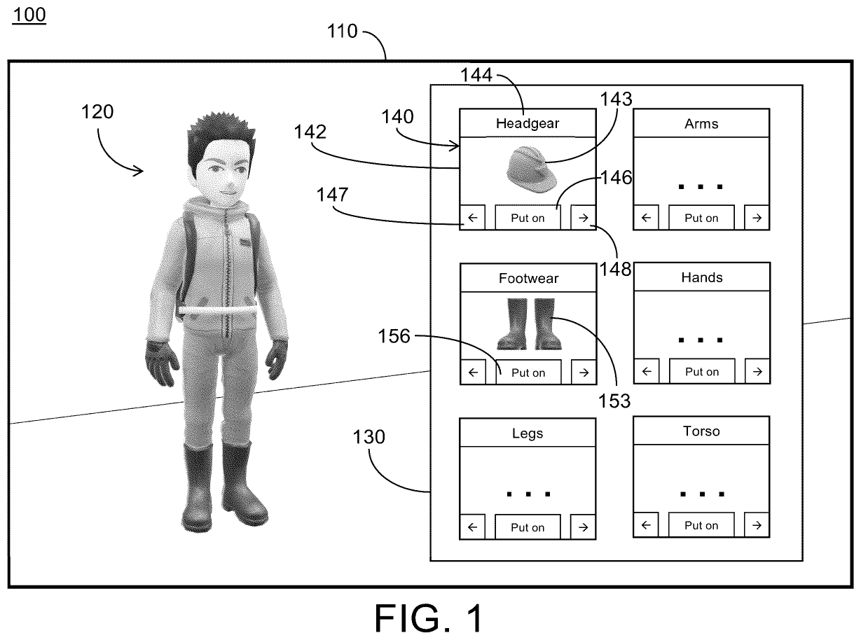

FIG. 1 illustrates an example screen layout 100 of a graphical user interface 110 for a 3D asset compiler. On the left is an example avatar 120. On the right is an asset selection interface 130. There can be multiple classes of assets, such the examples of Headgear, Arms, Footwear, Hands, Legs, and Torso shown in FIG. 1. The asset class 140 of Headgear can be shown via an asset window 142, an asset item 143, a class label 144, an asset selection button 146, a previous-asset button 147, and a next-asset button 148. The asset window 142 can show the asset item 143, here shown as an example helmet. The class label 144 can identify the asset class for the asset window 142, here shown as Headgear.

As shown in FIG. 1, the avatar 120 is not wearing the asset item 143 helmet. When a user executes (e.g., via a mouse-click, a touchscreen tap, a game controller button, etc.) the asset selection button 146 (“Put on”), the 3D asset compiler can alter the appearance of the avatar 120 to be wearing the asset item 143 helmet. The avatar 120 shown in FIG. 1 is wearing the asset item 153 boots of the Footwear asset class, which a user could have previously selected by previously executing the asset selection button 156, so that it is showing in FIG. 1.

Each asset class may include any number of asset items. For example, the asset class Headgear may include the helmet (as shown); another helmet having a different shape or size or color, etc.; zero or one or more varied hats; zero or one or more varied visors; zero or one or more varied glasses; etc. Such multiple asset items may be ordered in a list. When a user executes (e.g., via a mouse-click, a touchscreen tap, a game controller button, etc.) the previous-asset button 147, the asset window 142 may show a previous asset item in the list before the shown helmet. When a user executes (e.g., via a mouse-click, a touchscreen tap, a game controller button, etc.) the next-asset button 148, the asset window 142 may show a next asset item in the list after the shown helmet. The number of modular asset items may be basically unlimited. FIG. 1 shows six exemplary asset classes, but embodiments may include more than six or less than six.

The asset class Arms may include a list of varied asset items for the arms of the avatar 120, which is showing plain sleeves of a jacket in FIG. 1. The asset class Hands may include a list of varied asset items for the hands of the avatar 120, which is showing gloves in FIG. 1. The asset class Legs may include a list of varied asset items for the legs of the avatar 120, which is showing plain pants in FIG. 1. The asset class Torso may include a list of varied asset items for the torso of the avatar 120, which is showing a zippered jacket in FIG. 1. Where there are multiple asset item choices in an asset class, the asset item worn by the avatar 120 can be changed into a different asset item by a user's interactions with the 3D asset compiler.

FIG. 1 shows a humanoid avatar 120, but embodiments may include a non-humanoid avatar 120, such as animals, vehicles, mythical beings, etc. FIG. 1 shows asset classes associated with humanoid avatars, but embodiments may include different asset classes associated with non-humanoids, such as wings and horns for animals, wheels and doors for vehicles, etc. FIG. 1 shows asset classes of wearable objects, but embodiments may include different asset classes of equipment, such as weapons, tools, gear, etc. Embodiments may include other asset classes of companions (for the avatar 120), such as robots, animals, humanoids, etc. Some embodiments may include digital assets that are two-dimensional (2D), such as paintings, artwork, flat video displays, etc., which can be imported into a 3D asset compiler as a flat or thin or thick 3D object, such as a standalone object or a placement into a bordered picture frame.

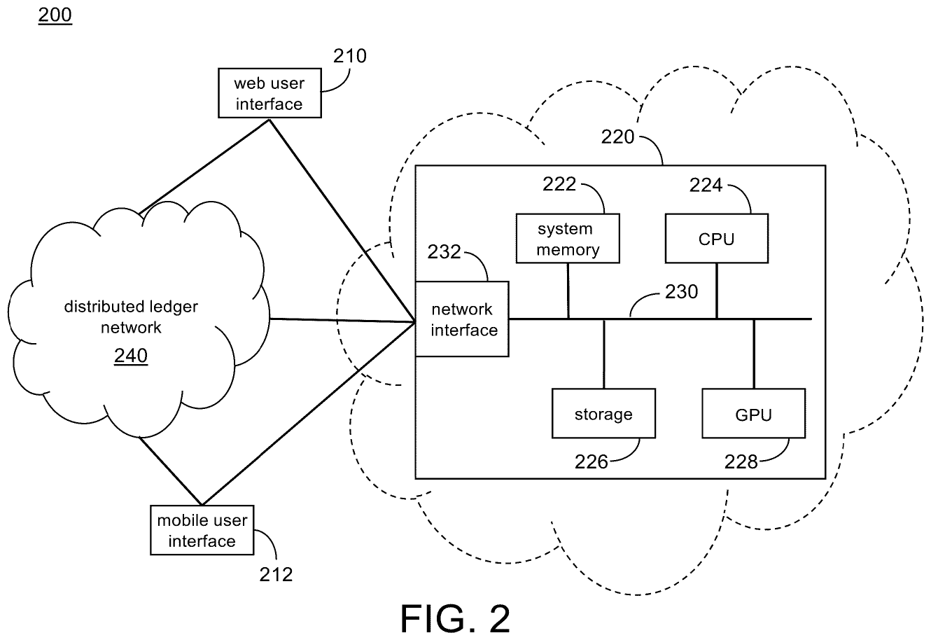

FIG. 2 illustrates an exemplary embodiment of a system 200 operating a 3D asset compiler. System 200 can embody equipment and services for operating a 3D asset compiler and for generating and/or maintaining various digital assets (including composed avatars 120, uncomposed avatars 120, various asset items 143, etc.). System 200 can perform services that operate the 3D asset compiler and that host digital assets via circuitry 220, which circuitry may be implemented in one or more stand-alone computers, in a cloud computing network, or other suitable computing device, etc. The circuitry 220 may include storage 226 (e.g., hard drive(s), solid-state drive(s), other storage media, database(s), combination of storage devices) to store data, such as the data of the 3D asset compiler (e.g., various parameters and specific parameter values indicating, defining, or describing relationships between file types/formats and target use cases and other capabilities, related servers, rendering history and details, related processors, etc.), data of various digital assets (e.g., various parameters and specific parameter values indicating, defining, or describing relationships between asset classes/types and layers/surfaces and other characteristics, related servers, rendering history and details, related processors, etc.), system software, cloud software, data for a machine learning model(s), etc. This storage 226 may include one or more storage medium devices that store data involved in the operation of the 3D asset compiler and interaction with various digital assets. Circuitry 220 may include circuitry 224, e.g., one or more central processing units (CPUs) including one or more main processors, to execute software or firmware or other kinds of programs that cause circuitry 220 to perform the functions of circuitry 220. In this disclosure, processors may include any, or a combination, of discrete componentry, microprocessor(s), microcontroller(s), programmable logic device(s), programmable gate array(s), ASIC(s), digital signal processor(s), or the like, configured to process instructions. Circuitry 220 may include circuitry 228, e.g., one or more graphics processing units (GPUs), to perform functions for machine learning. The CPU(s) and GPU(s) may perform functions involved in the operation of the 3D asset compiler and interaction with various digital assets. Throughout this disclosure, functions performed by GPU(s) 228 may also be performed by CPU(s) 224 or by GPU(s) 228 and CPU(s) 224 together. Circuity 220 may include system memory 222 (e.g., RAM, ROM, flash memory, or other memory media) to store data, such as data to operate circuitry 220, data for an operating system, data for system software, data for cloud software, etc. Some or all of the components or elements of circuitry 220 may be interconnected via one or more connections 230, such as buses, cables, wires, traces, network connections (e.g., wired, wireless), etc.

Users of system 200 can interact with functions of operation of the 3D asset compiler and interaction with various digital assets. Circuitry 220 may connect to a web user interface 210 and/or to a mobile user interface 212 (each typically including, but not limited to, one or more display screens) via communications through a network interface 232. Web user interface 210 and mobile user interface 212 may include user interface(s) and display(s) to receive inputs from and/or provide outputs to the user(s). Such user interface(s) may include, e.g., manual operators such as button(s), rotary dial(s), switch(es), touch surface(s), touchscreen(s), stylus, trackpad(s), mouse, scroll wheel(s), keyboard key(s), etc.; audio equipment such as microphone(s), speaker(s), etc.; visual equipment such as camera(s), light(s), photosensor(s), etc.; environment sensing equipment such as LIDAR, gyro sensors, accelerometers, GPS units, etc.; and/or any other conventional user interface equipment. Displays of web user interface 210 and mobile user interface 212 may be housed or integrated with element(s) of external devices, such as in a monitor or a panel display that includes a touchscreen, microphone, speakers, and a camera, to receive user inputs and to provide system outputs to a user. Such display(s) can graphically present activity related to the operation of the 3D asset compiler and interaction with various digital assets. Web user interface 210 may be part of a computing device such as a laptop computer or desktop computer. Mobile user interface 212 may be part of a mobile device such as a smartphone or mobile computing headset.

In some embodiments, circuitry 220 may store, or be hard-coded with, instructions constituting an operating system or cloud software to run operations of circuitry 220. In some embodiments, circuitry 220 may include circuitry, e.g., FPGA or ASIC, or some combination of hardware circuitry and software to run operations of circuitry 220. Via some or all of the above components, circuitry 220 can receive user inputs and perform operation of the 3D asset compiler and interaction with various digital assets.

Circuity 220 may be implemented in various form factors and implementations. For example, circuitry 220 can be deployed on one or more local machines such as a PC or workstation. As another example, circuitry 220 can be deployed in one or more servers among one or more data centers. As yet another example, circuitry 220 may be deployed in one or more servers in a secure public cloud or a private cloud. Users may access such local and/or remote circuitry 220 through a web user interface or mobile user interface.

Various digital assets may be provided via one or more three-dimensional (3D) experience platforms, such as a 3D experience engine and/or a 3D video game engine. Such a 3D experience platform may be provided by circuitry 220 embodied as a server running one or more corresponding program(s) stored in storage 226 and/or system memory 222. The server can run one or more programs to generate, maintain, and operate various digital assets on the 3D experience platform, and the digital assets may be accessible by users via, e.g., a web browser or a dedicated app. A user can operate and interact with digital assets (such as avatar 120 and asset items) via, e.g., web user interface 210 or mobile user interface 212. A digital asset's visual appearance and interactive experience may be rendered at the server-side (e.g., at circuitry 220) or at the client-side (e.g., at web user interface 210 or mobile user interface 212) or via a combination of processes at both the server-side and the client-side. Server-side activity (e.g., loading an avatar 120, rendering an avatar 120, storing/saving changes about an avatar 120, etc.) may result in a faster experience for a user due to several technical aspects. For example, the server (e.g., its hardware and software) may pre-load and/or pre-render elements for the user's client to simply access when starting; thus, there is less work for the client-side user's hardware to do when starting. As another example, the server can manage synchronization of user-experiences by different users; thus, client-side users' hardware are not burdened with such management tasks. Client-side activity (e.g., rendering an avatar 120 in accordance with a user's selection(s) on a 3D asset compiler) may be useful for some aspects. For example, the client (e.g., its hardware and software) may have a local cache(s) or store cookie(s) that can store data related to a user's local or short-term activity (e.g., preferences, pre-set configurations, recent history, 3D asset compiler activity, etc.); thus, the client-side user's hardware needs not obtain such data from the server, which can result in a smoother experience for a user by avoiding reliance on the server for such data. Combination of processes at both the server-side and the client-side can incorporate advantages and benefits of both.

Ownership of various digital assets may be obtained, maintained, and/or authenticated via digital ledger operations (using, e.g., the ETHEREUM blockchain) stored in a distributed ledger network 240. For example, ownership of an avatar 120 may be linked to a unique digital token, e.g., an NFT stored on-chain at a unique digital address such as an address on the ETHEREUM blockchain (or at a unique identifier among other identifiers that all share the same ETHEREUM address) belonging to the owner of the avatar 120. That unique ETHEREUM address may be provided to the owner. In some embodiments the unique ETHEREUM address may be stored in the owner's digital wallet. As an example use case, when the owner of the avatar 120 at web user interface 210 opens a web browser at the website address of an asset-displaying service (e.g., a 3D asset compiler) hosted by circuitry 220 as a remote asset-displaying server, the server can prompt the user or give the user an option to connect her digital wallet to the server. Her digital wallet may have the ownership NFT for authentication of the avatar 120 at the wallet's (e.g., ETHEREUM) address in the distributed ledger network 240. The owner can check her wallet's contents by using her web user interface 210 to communicate with the distributed ledger network 240 to show her the wallet's contents on her browser screen, including the ownership NFT for the avatar 120 and any ownership NFTs for any other digital assets. Via her browser, the owner can mouse-click or finger-tap her avatar 120 listed or shown on the asset-displaying service website in order to access avatar 120 (and/or any other digital asset). The asset-displaying server (circuitry 220) can show the user the avatar 120 (and/or any other digital asset) on the display of her device, e.g., in a 3D asset compiler. By incorporating digital-ledger technology (e.g., NFT technology), digital assets of this disclosure can introduce technological improvements, including improved data security (e.g., unalterable and persistent on-chain data stored on digital ledger network), improved data transparency (e.g., single immutable unitary ledger of digital ledger network), improved tracking of digital assets (e.g., immutable activity history of digital ledger network), faster speed and more efficiency (e.g., unnecessary to perform tasks of reconciling multiple ledgers when digital assets move), automation capabilities (e.g., NFT token-gating where digital access can be automatically provided to various user's hardware/software based on NFT movement), etc.

In addition to its graphical and interactive features, various digital assets may include one or more default parameter values, such as a date or other identifier representing when the owner first obtained ownership of the digital asset. Based on the default parameter values, the asset-displaying server (circuitry 220) can show the digital asset as having some default traits or default features such as default color, shape, texture, pattern, etc. In contrast to conventional digital assets of 2D-patterned skins in a conventional 3D video game, various digital assets in a 3D asset compiler may be actual 3D objects each with various 3D parameters.

When importing NFT assets into an asset-displaying service (e.g., a 3D asset compiler), the asset-displaying server (circuitry 220) can place NFT assets in a 3D asset compiler, as shown in FIG. 1. In order to import her NFT assets into the 3D asset compiler, an owner at web user interface 210 may select one or more of her NFT assets in her digital wallet via a web browser. The web user interface 210 may be communicating with distributed ledger network 240 to view the contents of the digital wallet and also communicating with the asset-displaying server (circuitry 220) to instruct the asset-displaying service website to import one or more of her NFT assets in the digital wallet. The asset-displaying server (circuitry 220) may communicate with distributed ledger network 240 to retrieve the NFT asset(s) stored on-chain in the distributed ledger network 240 or off-chain in another storage location at an address where data of the NFT asset(s) may indicate via a link or another kind of pointer. The asset-displaying server (circuitry 220) can import the NFT asset(s) as objects in the 3D asset compiler.

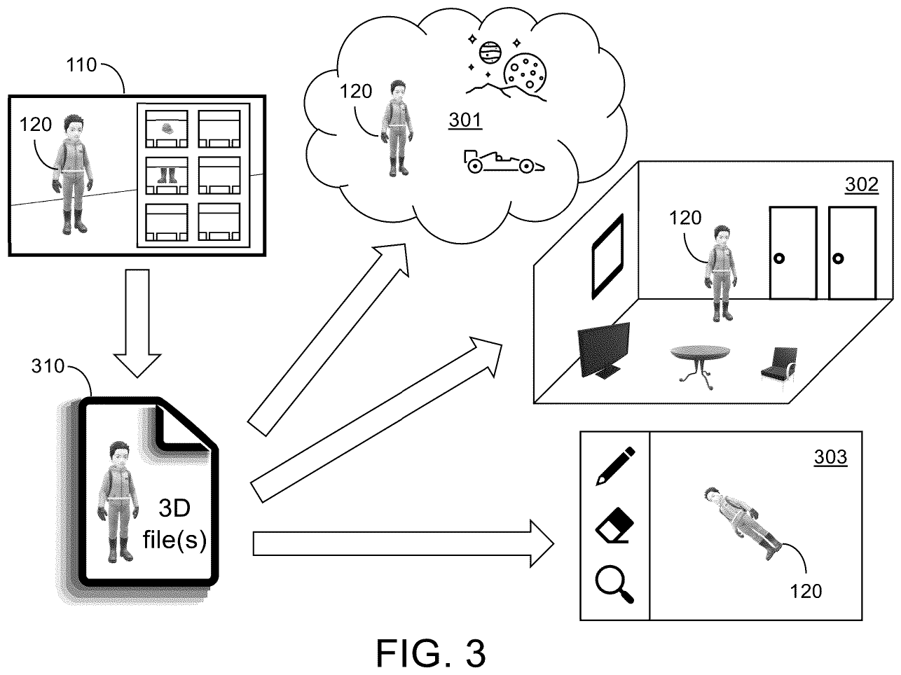

FIG. 3 illustrates an output 3D file from a 3D asset compiler and example uses of the 3D file. The 3D asset compiler, indicated by the graphical user interface 110, is able to compile together, combine together multiple 3D asset items with the avatar 120 in real-time on the fly to create custom 3D file(s) 310 and export those files. A user may be an owner of their non-fungible token (NFT) assets (e.g., an avatar 120 and one or more of the asset items of one or more of the asset classes in FIG. 1), and via the 3D asset compiler, the user can compose a fully-fledged 3D rigged and equipped avatar 120. The user can export that composed avatar 120 as a native 3D file 310.

The native 3D file 310 can be imported into digital environments, such as video game world(s) 301 and digital place(s) 302, and digital workspace(s) 303, so that the avatar 120 of the 3D file 310 is instantiated into those digital environments and digital workspace(s), as shown in FIG. 3. The different digital environments 301, 302 and digital workspace(s) 303 can be provided by circuitry 220 embodied as one or more servers running one or more corresponding program(s) stored in storage 226 and/or system memory 222. The user can create a desired avatar 120, composed of multiple assets based on a user's selections made on the 3D asset compiler (e.g., via the graphical user interface 110), which the user can access via, e.g., web user interface 210 or mobile user interface 212. In some embodiments, the 3D asset compiler can be run on a computing device, and the user can export the composed avatar 120 as a 3D file from the 3D asset compiler to the back-end components, such as server(s) and/or database(s) for further processing and/or storage.

The avatar 120 can be created via a three-dimensional (3D) experience platform, such as a 3D experience engine and/or a 3D video game engine. Such a 3D experience platform may be provided by circuitry 220 embodied as a server running one or more corresponding program(s) stored in storage 226 and/or system memory 222. For example, the avatar 120 can be built by of an established third-party 3D video game engine, which can simplify the amount of steps needed as compared to creating an entirely new 3D experience platform.

In some embodiments, a 3D asset compiler can import a basic avatar 120, e.g., that lacks other digital assets, that is not wearing any digital assets, etc. For example, the basic avatar 120 can be built via a first established third-party 3D video game engine. After compiling one or more asset items with the avatar 120 via the 3D asset compiler, as exemplified in graphical user interface 110 in FIG. 3, a user can export the compiled or composed avatar 120 in a 3D file 310. The 3D asset compiler can have the ability to export the composed avatar 120 according to various export file types, including the same file type as the first established third-party 3D video game engine, a different file type such as a second established third-party 3D video game engine, and/or another different file type such as an open standard 3D file type (e.g., GLB file, GLTF file, etc.). The different export file types can have different features, benefits, and/or advantages. For example, a GLB file or a GLTF file may be well-suited or optimized for usage with web browsers and websites, kind of like a drag-and-drop style. Embodiments may be compatible (e.g., import and/or export) with various 3D file types, including GLB, GLTF, FBX, OBJ, etc.

In some embodiments, a 3D asset compiler can be based on a first 3D experience platform or file type, and the same 3D asset compiler can import digital assets that were generated based on a different second 3D experience platform or file type. For example, the 3D asset compiler can import an avatar 120 that was generated based on one established third-party 3D video game engine, and the same the 3D asset compiler itself can be based on a different established third-party 3D video game engine for performing the compiling of digital assets with that imported avatar 120.

In some embodiments, a 3D asset compiler can be a universal 3D asset compiler that can, e.g., import one or more digital asset(s) of any of one or more 3D file type(s), compile multiple digital assets of any of one or more 3D file types, and then export a compiled 3D asset in any of one or more 3D file types. For example, a 3D asset compiler can import a first digital asset built from a first 3D video game platform and a second digital asset built from a second 3D video game platform, where the importing process includes functionality to check that or make the first and second imported digital assets compatible with each other within the 3D asset compiler, and then the 3D asset compiler can combine them together into an composed or compiled whole 3D model, which the 3D asset complier than then export into a 3D file type that is readable by a wide variety of 3D software. In some embodiments, that widely readable 3D file type can become an industry standard. In some embodiments, that widely readable 3D file type is a GLB file or a GLTF file. In some embodiments, that widely readable 3D file type is a native novel 3D file type that is based at least 5% on another prior 3D file type, wherein that at least 5% is based on generic features. The UI and/or UX design of the 3D asset compiler can be so intuitive that a novice user can proficiently utilize the 3D asset compiler without hours of training such as with professional 3D software tools. Various digital assets in a 3D asset compiler may be modular, so that they can fit and interface with each other like interchangeable modules of a larger modular system.

An example, but non-limiting, use of an avatar 120, compiled or composed by a 3D asset compiler, may be as an importable avatar 120 into a video game world 301 in FIG. 3. The imported avatar 120 may be a first-person 3D avatar in a first-person 3D shooter video game having a sci-fi theme. The 3D asset compiler can output a 3D file 310 that has the file type of a first 3D video game engine. When the first-person 3D shooter video game is also based on the same first 3D video game engine, the avatar 120 of that 3D file 310 can be compatibly imported into that first-person 3D shooter video game and readily playable as the first-person 3D avatar. In some embodiments, within the 3D asset compiler, the graphical user interface 110 may also be based on the same first 3D video game engine. In some embodiments, within the 3D asset compiler, the graphical user interface 110 may be based on a different second 3D video game engine, and the 3D asset compiler can export avatar 120 as an output 3D file 310 that has the file type of the first 3D video game engine. In some embodiments, within the 3D asset compiler, the graphical user interface 110 may be based on a 3D experience engine native to the 3D asset compiler, and the 3D asset compiler can export avatar 120 as an output 3D file 310 that has the file type of the first 3D video game engine. In some embodiments, the 3D asset compiler can output a 3D file 310 that has the output file type of an industry standard or a widely readable 3D file type, where the output file type is readable by a first 3D video game engine and/or a second 3D video game engine.

Another example, but non-limiting, use of an avatar 120, compiled or composed by a 3D asset compiler, may be as an importable avatar 120 into a digital place 302 in FIG. 3. The imported avatar 120 may be a first-person or third-person 3D avatar (e.g., humanoid, animal, vehicle, etc.) in a digital space of any shape or volume (e.g., a single room, a multi-room apartment or condo or house or office, an art exhibition hall, garage, a vehicle, a boat, etc.). The 3D asset compiler can output a 3D file 310 that has the file type of a first 3D experience platform. When the digital space is also based on the same first 3D experience platform, the avatar 120 of that 3D file 310 can be compatibly imported into that digital space and readily usable as the first-person or third-person 3D avatar. In some embodiments, within the 3D asset compiler, the graphical user interface 110 may also be based on the same first 3D experience platform. In some embodiments, within the 3D asset compiler, the graphical user interface 110 may be based on a different second 3D experience platform, and the 3D asset compiler can export avatar 120 as an output 3D file 310 that has the file type of the first 3D experience platform. In some embodiments, within the 3D asset compiler, the graphical user interface 110 may be based on a 3D experience engine native to the 3D asset compiler, and the 3D asset compiler can export avatar 120 as an output 3D file 310 that has the file type of the first 3D experience platform. In some embodiments, the 3D asset compiler can output a 3D file 310 that has the output file type of an industry standard or a widely readable 3D file type, where the output file type is readable by a first 3D experience platform and/or a second 3D experience platform.

With this present disclosure, a user's digital place having a digital space (e.g., a digital personal room or digital housing enclosure structure) may be a decentralized digital asset owned by the user, for instance a digital room authenticated by an NFT stored on a distributed ledger, such as, but not limited to, the ETHEREUM, AVALANCHE, or SOLANA blockchains (including multi-layer approaches). A user's digital place may be a digital asset that is not authenticated by an NFT stored on a distributed ledger, e.g., an account that employs a username/password login access to one or more servers hosting the digital place, without requiring NFT-authentication or distributed ledger technology. Embodiments of such digital places may be referred to as METAGATES in the present disclosure. Additional details for digital places are disclosed in U.S. patent application Ser. No. 18/191,799, filed on Mar. 28, 2023, titled “SYSTEMS, METHODS, AND COMPUTER-READABLE MEDIA FOR DIGITAL PLACES,” the contents of which are incorporated by reference in its entirety for all purposes.

Yet another example, but non-limiting, use of an avatar 120, compiled or composed by a 3D asset compiler, may be as an importable avatar 120 into a digital workspace(s) 303 in FIG. 3. The imported avatar 120 may be viewed or edited by a digital workspace tool(s), such as MICROSOFT 3D VIEWER or BLENDER or, etc. The 3D asset compiler can output a 3D file 310 that has a file type compatible with digital workspace tool(s), so that the avatar 120 of that 3D file 310 can be compatibly imported into that digital workspace tool and readily viewable or editable. In some embodiments, within the 3D asset compiler, the graphical user interface 110 may also be based on the same file type as the output 3D file 310. In some embodiments, within the 3D asset compiler, the graphical user interface 110 may be based on a different file type, and the 3D asset compiler can export avatar 120 as an output 3D file 310 compatible with digital workspace tool(s). In some embodiments, within the 3D asset compiler, the graphical user interface 110 may be based on a 3D experience engine native to the 3D asset compiler, and the 3D asset compiler can export avatar 120 as an output 3D file 310 compatible with digital workspace tool(s).

When imported into digital environments, such as video game world(s) 301 and digital place(s) 302, and digital workspace(s) 303, an avatar 120 may look the same as when in the 3D asset compiler. Alternatively, each of the digital environments and digital workspaces may import avatar 120 in a manner that the imported avatar 120 looks different from when in the 3D asset compiler, e.g., different size, different color scheme, etc., and thus designers of the digital environments and digital workspaces have flexibility to make the imported avatar 120 appear as they want. However, in the case that the imported avatar 120 has a corresponding ownership NFT externally in a distributed ledger network 240, appearance modifications by digital environments and digital workspaces may be limited to their internal contexts.

In some embodiments, the importing function may be implemented as an Application Programming Interface (API) that a 3D experience platform can access in a seamless manner characteristic of APIs. For example, a user can utilize a 3D asset compiler to generate a composed or compiled avatar 120. Then, from within a video game, a user can import that composed avatar 120 into the video game via API call(s). The 3D experience platform of the video game can send an API call(s) to a back-end server where the composed avatar 120 may be located or accessible (e.g., by the 3D asset compiler), and the back-end can confirm that the composed avatar 120 is set up with parameters suitable for the video game's platform. The third-party video game's platform can check that an incoming user has a certain avatar with equipment. The back-end server can inform the video game's platform about the composed avatar 120, its equipment, and any requisite parameters that the video game's platform or world recognizes in order to confirm playability or importability (e.g., a rigged avatar following or based on a trait system compatible with Unreal engine). The 3D asset compiler can send 3D model information and/or file(s) (e.g., about composed avatar 120) to the APIs, where the video game can accept the 3D model information and/or file(s) and subsequently convert them into its game world for making the composed avatar 120 playable or importable into the video game. The operating parameters of the video game's platform or world (e.g., compatible file types, trait classification systems, etc.) can limit or restrict or specify or determine how or what to import a called digital asset (e.g., Is this an avatar? Is this a companion? Is this furniture?). Independent from the original designers of the video game, a user can creatively compile together a combination of various digital assets that have never been combined together by the original designers. In some embodiments, the 3D model information and/or files(s) may include a dataset(s) (e.g., a plurality of 3D model files packaged in a single file archive) and accompanying software tools (e.g., for unpackaging the single file archive into the original plurality of 3D files), which may all be packaged into a single output 3D file 310.

The 3D asset compiler can be implemented as a standalone tool. The 3D asset compiler can be implemented as a universal standard tool. The 3D asset compiler can be implemented within a third-party 3D experience platform. The 3D asset compiler can be implemented within a video game world or a digital place or other digital environment.

The 3D asset compiler can handle various digital assets that may be NFT assets or non-NFT assets or combinations thereof. When a user (via her instructions to her web user interface 210 or her mobile user interface 212) connects her digital wallet (which has NFT asset(s) whose ownership NFT(s) are in a distributed ledger network 240) to the 3D asset compiler (implemented by circuitry 220), the 3D asset compiler may communicate with the distributed ledger network 240 to retrieve the NFT asset(s) stored on-chain in the distributed ledger network 240 or off-chain in another storage location at an address where data of the NFT asset(s) may indicate via a link or another kind of pointer. Thus, the 3D asset compiler can import the NFT asset(s) of her digital wallet, e.g., to be shown in a graphical user interface 110. When a digital asset in the user's digital wallet is an NFT asset, the 3D asset compiler can perform token-gating to verify and retrieve the NFT asset; for example, the 3D asset compiler can communicate with the distributed ledger network 240 based on the ownership NFT in the user's digital wallet to identify and retrieve the corresponding NFT asset.

After the 3D asset compiler performs token-gating to verify and retrieve the NFT asset(s) when importing the NFT asset(s), the output avatar 120 (composed or compiled with the NFT asset(s)) may be imported into a 3D experience platform. For example, a video game may import the output avatar 120, composed or compiled with the NFT asset(s), but may omit performing token-gating, since the 3D asset compiler already did so upstream. When an output 3D file 310 is available, the video game may simply import the corresponding output avatar 120 to be playable by a user. Alternatively, when a video game is designed to maintain an NFT asset's unique digital instantiation, the video game may perform its own token-gating based on the NFT asset included by the output avatar 120.

In some embodiments, the 3D asset compiler can handle a set of various digital assets (e.g., avatar 120 and 3D asset items) where none is an NFT asset. The 3D asset compiler can compose or compile the various (non-NFT) digital assets into an output avatar 120 into an output 3D file 310. The output avatar 120 (composed or compiled with the non-NFT digital assets) may be imported into a 3D experience platform, such as into a video game to be playable by a user. When an output avatar 120 lacks NFT assets, the 3D asset compiler (implemented by circuitry 220) can perform its compiling functionality separate from a distributed ledger network 240. In some embodiments, the 3D asset compiler can operate independently from whether an imported digital asset is an NFT asset or a non-NFT asset.

In some embodiments, users can utilize the 3D asset compiler to customize and produce their own 3D models, including in real-time, and to export them. In some embodiments, a 3D asset compiler may be a cross-platform interoperability tool that can export a 3D file with rigging and texture. The asset compiler can convert native or third-party content into a fully-fledged 3D file output. In some embodiments, the 3D asset compiler can provide cross-platform modular creation without a user having a sophisticated knowledge base or expertise with using 3D software.

The 3D asset compiler's native environment (e.g., based on a native engine, native processes, and/or native file type(s), etc.), which may incorporate native aspects with (or without) third-party aspects, can be utilized as a standard for cross-platform interoperability. Some conventional 3D file types and formats require a highly sophisticated 3D digital workspace tool to edit, view, or modify a 3D model of that 3D file type (or format), where a proficient user needs to have extensive experience and knowledge in 3D modeling techniques and software tools. In contrast, the 3D asset compiler may employ a native 3D file type (or format) where a user can handle the 3D file with a user-interface (UI) design and user-experience (UX) design that is a drag-and-drop UI/UX design, easy for basic users to intuitive learn without sophisticated 3D modeling knowledge or experience. With the drag-and-drop UI/UX design, a user can drag-and-drop the 3D model or 3D file into different 3D experience platforms to be played, viewed, edited, handled, controlled, etc.

For a humanoid avatar, such as avatar 120 in FIG. 1, the 3D asset compiler's native 3D file type (or format) may accommodate a standard template for humanoid avatars. For example, such an avatar template may have a certain size for headgear and certain connection point(s) for the headgear. Correspondingly, the avatar template may have a certain size and certain connection point(s) for each of a legs asset item, a torso asset item, an arms asset item, etc., respectively. Additionally, the avatar template may then have aspects by which equipment can be put on.

In some embodiments, the 3D asset compiler's native standard templates for digital assets may be designed so as to be compatible with a third-party 3D experience platform(s) and still distinct from templates from that third-party 3D experience platform(s). In some embodiments, the 3D asset compiler can compatibly import a digital asset (e.g., an avatar) that was created based on a template(s) from a third-party 3D experience platform, and then the 3D asset compiler can customize that imported digital asset.

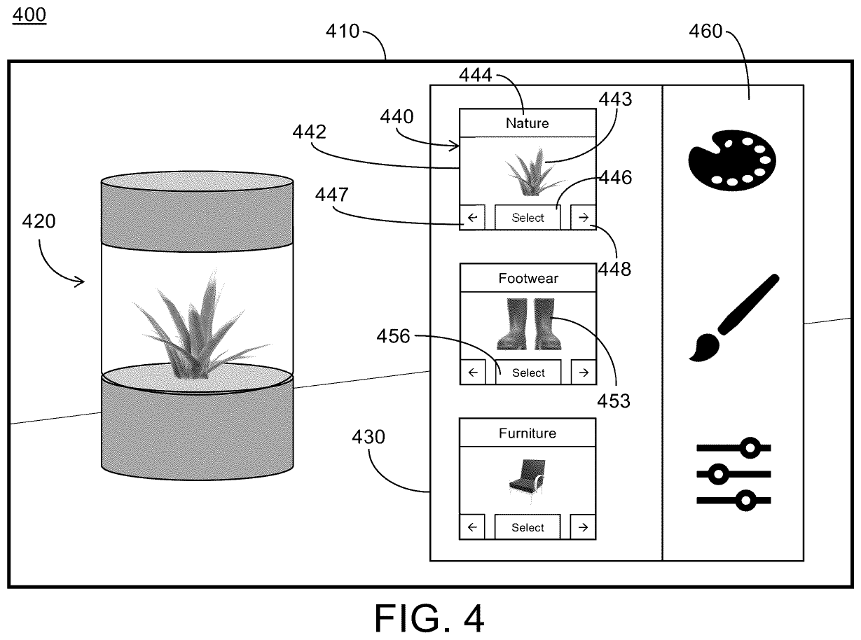

FIG. 4 illustrates an example screen layout 400 of a graphical user interface 410 for a 3D asset compiler. FIG. 4 is similar to FIG. 1 in some aspects, but different in others. FIG. 1 shows an example humanoid avatar 120, but FIG. 4 shows an example display case 420 on the left. On the right is an asset selection interface 430 to select what asset to show in the display case 420. There can be multiple classes of assets, such the examples of Nature, Footwear, and Furniture shown in FIG. 4. The asset class 440 of Nature can be shown via an asset window 442, an asset item 443, a class label 444, an asset selection button 446, a previous-asset button 447, and a next-asset button 448. The asset window 442 can show the asset item 443, here shown as an example plant. The class label 444 can identify the asset class for the asset window 442, here shown as Nature.

As shown in FIG. 4, the display case 420 is showing the asset item 443 plant. When a user executes (e.g., via a mouse-click, a touchscreen tap, a game controller button, etc.) the asset selection button 456 (“Select”), the 3D asset compiler can alter the appearance of the display case 420 to be showing the asset item 453 boots. The display case 420 shown in FIG. 4 is displaying the asset item 443 plant of the Nature asset class, which a user could have previously selected by previously executing the asset selection button 446, so that it is showing in FIG. 4.

Each asset class may include any number of asset items. Such multiple asset items may be ordered in a list. When a user executes (e.g., via a mouse-click, a touchscreen tap, a game controller button, etc.) the previous-asset button 447, the asset window 442 may show a previous asset item in the list before the shown plant. When a user executes (e.g., via a mouse-click, a touchscreen tap, a game controller button, etc.) the next-asset button 448, the asset window 442 may show a next asset item in the list after the shown plant. The number of modular asset items may be basically unlimited. FIG. 4 shows three exemplary asset classes, but embodiments may include more than three and less than three.

FIG. 4 shows a cylindrical display case 420, but embodiments may include any other shape, such as cuboid, rectangular box, spherical, egg-shaped, etc. In FIG. 4, the display case 420 envelops an asset item inside a contained space, but embodiments may include an open and uncontained space, such as an asset item may sit on a base or a stand (e.g., a digital statue sitting on a table). The graphical user interface 410 may include a panel/toolbar 460 including editing tools for modifying the display case 420 and/or the shown asset item 443 plant, e.g., color palette tool, brush tool, parameter adjustment tool, etc. The 3D asset compiler can be implemented as a standalone tool, separate from any other digital environment or digital workspace, e.g., the graphical user interface 410 shows a space contained within the standalone tool. The 3D asset compiler can be implemented within a 3D experience platform, e.g., the graphical user interface 410 shows a space contained within a video game world or a digital place or other digital environment.

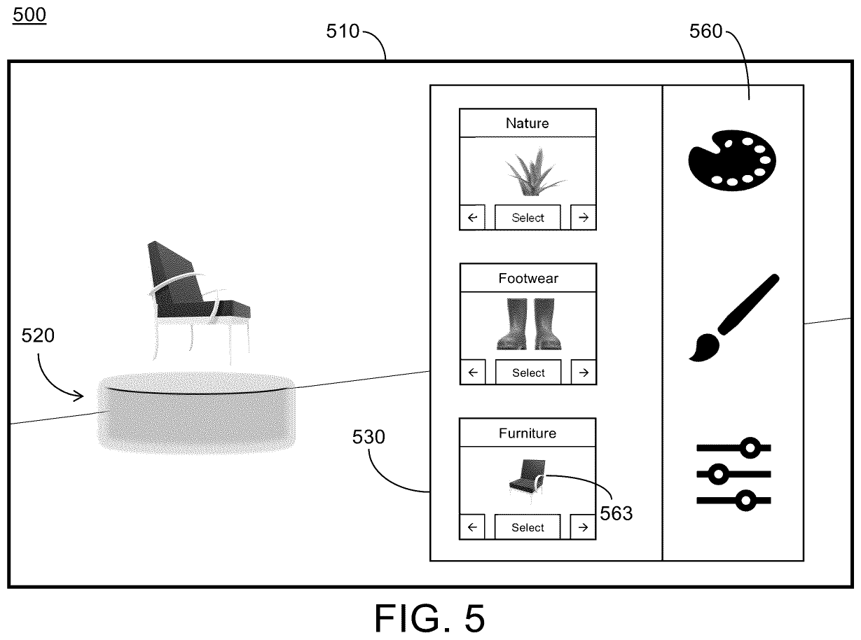

FIG. 5 illustrates an example screen layout 500 of a graphical user interface 510 for a 3D asset compiler. FIG. 5 is similar to FIG. 4 in some aspects, but different in others. FIG. 4 shows an example cylindrical display case 420, but FIG. 5 shows an asset item 563 chair hovering over an illuminating disk 520. On the right is an asset selection interface 530 to select what asset to show over the illuminating disk 520. The display technique in FIG. 5 may provide a more credible user experience when the displayed 3D asset item, here chair 563, has no or undetermined collider parameters or parameter values. When a 3D asset has determined collider parameters or parameter values, it can be determined where that 3D asset starts and ends as a physical object in a 3D experience platform. When a 3D asset lacks collider parameters or parameter values, that 3D asset may be an object that has no physical presence according to the physics of the 3D experience platform. For example, an avatar 120 may have a visual effect of walking through chair 563 when that chair lacks collider parameters or parameter values. The illuminating disk 520 and the hovering position of chair 563 can provide a user experience of a hologram effect, which can be more credible to a human user that controls an avatar 120 to walk through chair 563 with no collision effect. The hologram display technique in FIG. 5 may be useful when a user wants to introduce or display new 3D assets or 3D models (e.g., from a GLB or a GLTF file) into a digital environment for visual purposes, without needing to determine other aspects such as collider parameters or parameter values. FIG. 5 shows illuminating disk 520 where chair 563 fits within the circular perimeter of the disk 520, but other embodiments can use other shapes and/or other visual effects, e.g., a displayed asset item's boundaries may extend past the border of the display marker that is exemplified as the disk 520, a display marker may be square or rectangular (not circular or ellipsoid like the disk 520), a display marker may have a transparent or translucent box effect (instead of a hologram effect), etc. Detailed aspects of the visual effect may be adjustable. For example, the opacity of the displayed asset item may be adjustable, e.g., via a parameter adjustment tool in a panel/toolbar 560, so that a user can experience a see-through effect when viewing the displayed asset item.

With the display technique of FIG. 4, a 3D asset compiler may output a 3D file where the compiled or composed 3D model is the entirety of the display case 420 with the selected asset item 443 plant. Alternatively, when a user desires to no longer display an asset item in the display case 420, the user can instruct the 3D asset compiler to remove the asset item by deleting the visual instantiation of the asset item in the display case 420, without exporting anything. An original copy of the asset item, regardless of whether it is an NFT asset or a non-NFT asset, may remain unaltered and undeleted, also regardless of whether any object is exported or not.

With the display technique of FIG. 5, a 3D asset compiler may output a 3D file where the compiled or composed 3D model is the entirety of the illuminating disk 520 with the selected asset item 563 chair hovering above. Alternatively, when a user desires to no longer display an asset item with the illuminating disk 520, the user can instruct the 3D asset compiler to remove the asset item by deleting the visual instantiation of the asset item above the illuminating disk 520, without exporting anything. An original copy of the asset item, regardless of whether it is an NFT asset or a non-NFT asset, may remain unaltered and undeleted, also regardless of whether any object is exported or not.

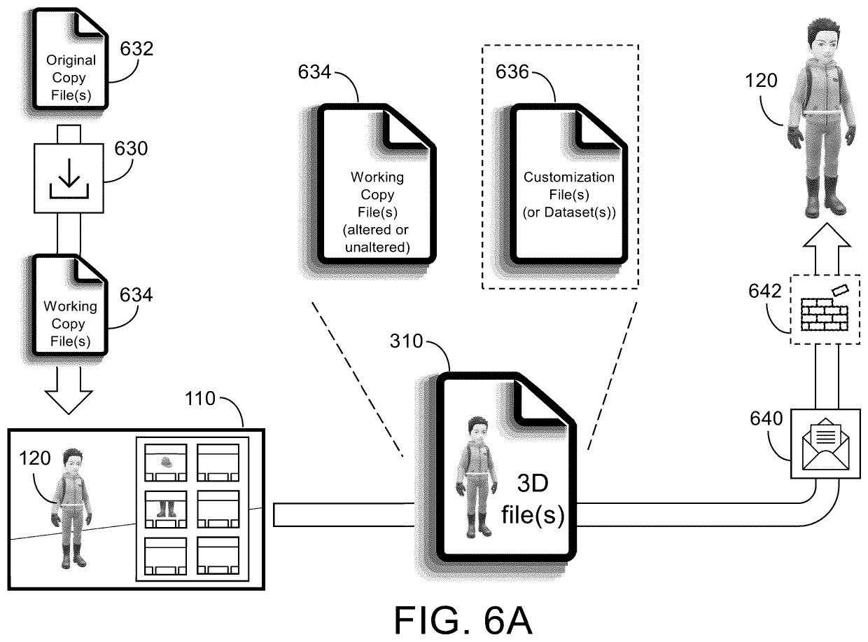

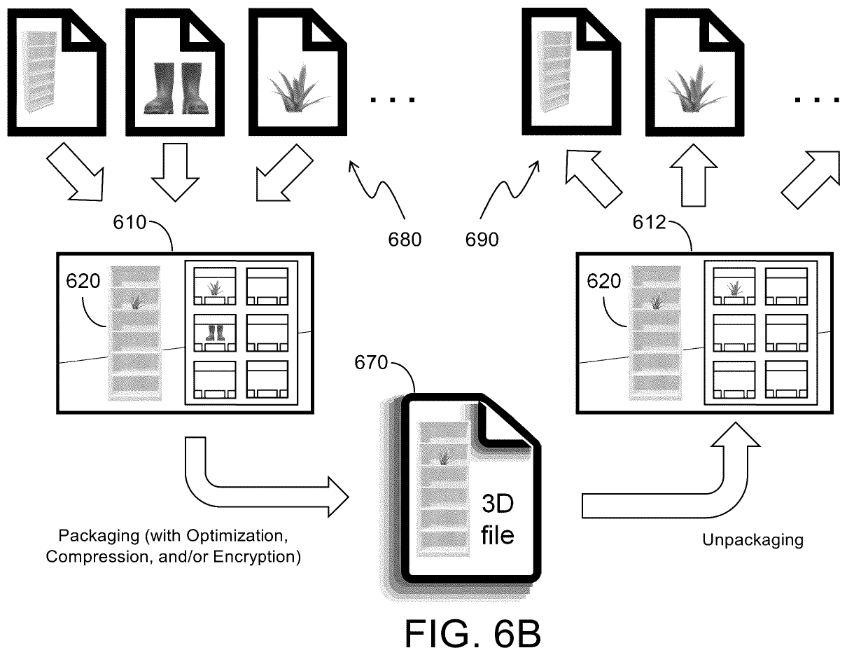

FIG. 6A illustrates example processes for 3D file generation and 3D model production. In some embodiments, when a digital asset is imported 630 into a 3D asset compiler (indicated by graphical user interface 110), an original copy file (or dataset) 632 of the digital asset may be duplicated to provide a working copy file (or dataset) 634 for the 3D asset compiler to work with. The original copy file (or dataset) 632 of the digital asset, regardless of whether it is an NFT asset or a non-NFT asset, may remain unaltered in its original storage location. In the 3D asset compiler, the working copy files(s) (or dataset(s)) 634 of any or all imported digital assets may be altered, modified, and/or combined in any manner described herein. For example, the visual instantiation(s) of digital assets in the 3D asset compiler may be working copies of the digital assets. Any or all alterations, modifications, combinations, etc. of the imported digital assets may be recorded or logged into a customization file(s) (or dataset(s)) 636 that may accompany or correspond to the original copy (or an unaltered copy of the original copy) of the digital asset.

In some embodiments, for a 3D model that comprises multiple digital assets (e.g., avatar 120 wearing one or more asset items), the 3D asset compiler can generate a respective customization file (or dataset) for each of the multiple digital assets, or the 3D asset compiler can generate a single master customization file (or dataset) for all of the multiple digital assets. The 3D asset compiler can export the customized 3D model as an output 3D file 310, which may include an unaltered copy of each digital asset in the 3D model along with the respective customization files (or datasets), or the single master customization file (or dataset), for all the multiple digital assets in the 3D model. For any 3D model viewer or editor that is compatible with the output 3D file 310, that viewer or editor may be programmed to produce and present the customized 3D model by opening 640 the unaltered copies of the digital assets in the 3D model and then assemble 642 the 3D model (e.g., of avatar 120) by performing the alterations, modifications, combinations, etc. that are recorded or logged into the respective customization files (or datasets) or the single master customization file (or dataset) for all the multiple digital assets in the 3D model. For example, the output 3D file 310 of a 3D model may be a GLB file or a GLTF file that includes all the customization datasets along with unaltered copies of the digital assets of the 3D model. In some embodiments, the processes for 3D file generation and 3D model production are lossless so that no data is lost. In some embodiments, the processes for 3D file generation and 3D model production tolerate some data loss.

In some embodiments that tolerate data loss, the processes for 3D file generation and 3D model production may involve a baked object(s) where a composed or compiled 3D object(s) is generated or produced in manner that removes or omits one or more internal layers or surface. Such a baked object(s) may retain only a single external layer or surface for the composed or complied 3D object(s). In FIG. 6A, the 3D asset compiler may generate such a baked object by performing alterations, modifications, combinations, etc. directly on a working copy file(s) (or dataset(s) of the 3D object, without recording or logging them into any customization file(s) or dataset(s) 636. The 3D asset compiler can generate output 3D file 310 such that the composed or complied 3D object (e.g., composed or compiled avatar 120) is saved as a whole unitary baked object (e.g., composed or compiled avatar 120 unified with its asset item(s), such as the boots, etc.), retaining only a single external layer or surface for the composed or compiled 3D object. Underneath that single external layer or surface, the data for an internal layer(s) or surface(s) may be removed or omitted. FIG. 6A shows a non-limiting example using avatar 120, and may be applicable to other examples such as a display case 420 (e.g., in FIG. 4), where a baked object may be the display case 420 together with a plant 443 asset item as a unitary whole. For any 3D model viewer or editor that is compatible with the output 3D file 310, that viewer or editor may be programmed to produce and present the customized 3D model by opening 640 the composed or complied 3D model (e.g., of avatar 120), without and any additional assembling 642 For example, the output 3D file 310 of a 3D model may be a GLB file or a GLTF file that includes the composed or compiled 3D model, without any accompanying customization dataset(s).

FIG. 6B illustrates example file optimization, compression, and/or encryption and unpackaging with a 3D asset compiler(s). In some embodiments, a 3D asset compiler can perform optimization and/or compression so that an output 3D file 670 is smaller in size than the sum of the files 680 of the digital assets added together (e.g., the sum of a bookshelf 620 complied with other asset items). An optimized or compressed output 3D file 670 can be useful to avoid memory constraints, e.g., a user's local computing device crashing when the memory cache of the user's web browser or dedicated app is utilized beyond a stable limit, such as 1 gigabyte (GB) of used memory. An optimized or compressed output 3D file 670 can be useful to reduce transmission time, e.g., a user's local computing device spending less time uploading or downloading smaller optimized or compressed 3D file(s) rather than larger unoptimized or uncompressed 3D file(s). For example, an output 3D file 670 may contain data for a bookshelf 620 compiled with 10 asset items, where the sum of their data files would exceed 10 GB without compression or optimization, but with compression or optimization the output 3D file 670 may be packaged into a single file of 1 GB. The optimization or compression may include reduction (e.g., automated or manual) of the number of vertices and reduction of the poly count, e.g., by any amount, such as 10% reduction for each. For some video games, a target poly count may be 60K or less. Example reduction(s) may include omitting, deleting, archiving, and/or compressing data of internal aspects of a composed bookshelf 620 and/or its asset items, where the internal aspects are not visible on any exterior view of the composed bookshelf 620, e.g., data on internal colliders of the composed bookshelf 620 and/or its asset items. Example reduction(s) may include omitting, deleting, archiving, and/or compressing data of an unavailable view of a digital asset inside a composed bookshelf 620 with an opaque rear wall, such as the unavailable rear wall view of the digital asset due to the opaque rear wall. In some embodiments, when the optimized or compressed output 3D file 670 is unpackaged by a 3D asset compiler, the 3D asset compiler can restore compressed or archived data to recover the full data of files 690 of the component digital assets in the 3D file 670. In FIG. 6B, three or more digital assets (e.g., a bookshelf 620, boots, a plant) were considered in a 3D asset compiler with graphical user interface 610, which eventually compiled together two or more digital assets (e.g., the bookshelf 620, the plant, but no boots) via packaging with optimization and/or compression into an output 3D file 670. The optimization and/or compression may archive and/or compress data of the internal surface of the bookshelf 620 and the bottom of the plant where they meet, any or all colliders where the bookshelf 620 and the plant meet, and/or the rear view of the plant that faces the opaque back wall of the bookshelf 620. The size of output 3D file 670 is smaller than the sum of files 680 of the digital assets added together. A 3D asset compiler with graphical user interface 612 unpackages the output 3D file 670, restoring compressed or archived data to recover the full data of files 690 of the component digital assets in the 3D file 310 (e.g., the bookshelf 620, the plant, but no boots). In some embodiments, a 3D asset compiler can perform encryption so that an output 3D file 670 is encrypted, with or without optimization and/or compression, for secure storage or transmission. In some embodiments, a 3D asset compiler can perform decryption so that an encrypted output 3D file 670 is decrypted. One or more steps of the packaging may be performed locally by a user's local computing device (e.g., for benefits of offline handling, such as increased speed, local backup, data privacy, etc.) or by a server away from the user (e.g., for benefits of online handling, such as online enterprise backup, reliability, data security, etc.) or by both (e.g., for benefits of shared handling, such as increased redundancy, resource load balancing, dynamic network optimization, etc.).

In some embodiments, a 3D asset compiler can create new objects, e.g., via templates of objects. Compared to creating a 3D object entirely from scratch, pre-determined templates of that 3D object can shorten the time and complexity that a user would need to navigate to finish creating the 3D object. From the template, a user can simply modify pre-determined variables for that template. In some embodiments, a 3D asset compiler can create new objects, e.g., via AI and/or ML tool(s). The 3D asset compiler can be running on a server hosted by circuitry 220, where GPU(s) 228 can perform AI and/or ML functions, including generating 3D objects based on input text prompts and/or 2D images, which themselves may be generated by GPU(s) 228 in response to input instructions (e.g., input text prompt(s) with or without input image(s)) from a user.

A 3D asset compiler can operate in a manner that runs quite smoothly for a browser-based experience for a user. A smooth user experience can be attributed to any number of contributing features. For example, a 3D asset compiler may be part of a 3D digital environment where the memory requirements are easily met on a user's local computing device (e.g., having a web user interface 210 and/or a mobile user interface 212) that accesses system 200. A digital place 302, including a 3D asset compiler, may be only 300-350 megabytes (MB) or smaller in size that a user can quickly download at today's common download speeds, even at less than 5G mobile data speeds, e.g., 10-30 seconds of downloading time. In contrast, a user's local computing device may have significantly more lag in network and device operation when handling a video game world 301 that can be much larger than a digital place 302.

As another example, a 3D asset compiler (as a standalone tool or part of a 3D digital environment or workspace) may be running on a server on circuitry 220, and the 3D asset compiler can access a storage location 226 that is local to, nearby, proximate to, or part of the server running the 3D asset compiler, where the storage location 226 is pre-loaded with working copies of digital assets previously pulled from the storage locations of the original copies of the digital assets. A 3D asset compiler can use an API to pre-pull instantiations (working copies) of digital assets from their original storage locations, which may be relatively far away in latency time (e.g., due to longer distance and/or lower bandwidth, etc.) from the server running the 3D asset compiler, into storage location 226, which may be relatively closer in latency time (e.g., due to shorter distance and/or high bandwidth, etc.). Later when a user is using the 3D asset compiler to work with the digital assets, the 3D asset compiler can quickly fetch those pre-pulled instantiations, instead of a user separately downloading working copies of the same digital assets onto his/her local computing device (e.g., having a web user interface 210 and/or a mobile user interface 212) and then uploading those downloaded working copies into the 3D asset compiler. With such techniques, a user of the 3D asset compiler can have a faster and smoother user experience with fewer user steps, lower waiting time, and more efficient usage of resources of system 220 and of the user's computing device.

Any or all of the teachings disclosed herein may be combined in any manner for a target use case. For example, one target use case for a 3D asset compiler may involve cross-platform compatibility for the output 3D model. A user may want to play a composed or compiled avatar 120 in a target digital environment, such as a target video game world or a target digital place, which may have predetermined specifications or requirements for a playable avatar (e.g., specified bendable joints, specified ranges of motion, specified animation(s), specifications for data size or format, etc.). In view of or based on the target digital environment, the 3D asset compiler can generate a 3D file(s) that meets such predetermined specifications or requirements.

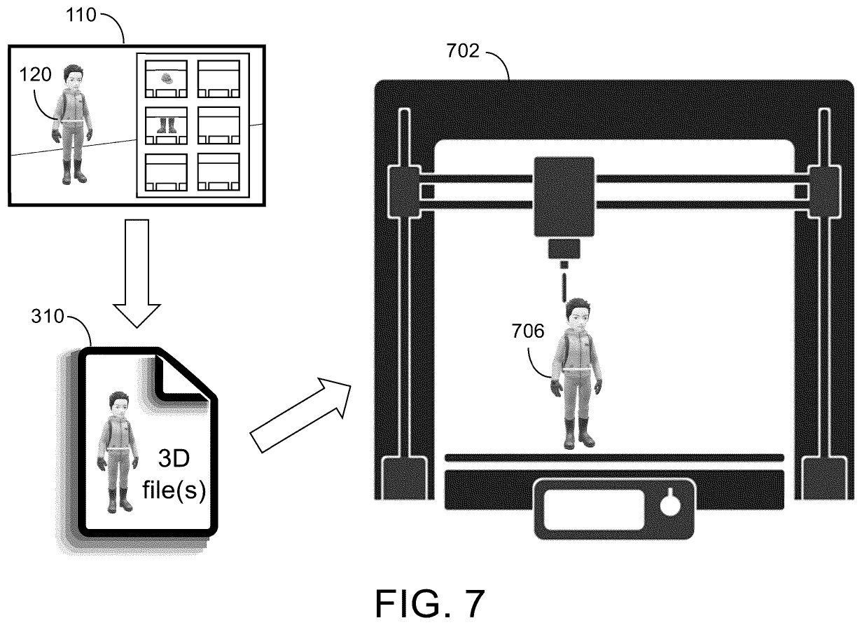

FIG. 7 illustrates an output 3D file 310 from a 3D asset compiler where the 3D file 310 is usable for 3D printing. A 3D asset compiler can export a 3D digital asset (e.g., composed of one or more digital assets) into a file type that is compatible with 3D printing technology, e.g., an STL file type, a computer-aided design (CAD) file type. A 3D asset compiler, indicated by the graphical user interface 110, is able to compile or combine together multiple 3D asset items with the avatar 120 in real-time on the fly to create custom 3D file(s) 310 and export those files, where the output 3D file(s) are compatible with 3D printer(s), e.g., an STL file type, a CAD file. A 3D printer 702 can receive the 3D file 310 by any suitable manner, e.g., any wired connection, any wireless connection, etc. Based on the 3D file 310 in a 3D-printable file format (e.g., STL file, CAD file), the 3D printer 702 can print a real-life physical model of the avatar 120. In some embodiments, a user's local computing device, via its web user interface 210 and/or mobile user interface 212, can access a 3D asset compiler running on a server (on circuitry 220). Then, the user can instruct the 3D asset compiler to output 3D file 310 to an online 3D printer 702 that is connected (e.g., by wired or wireless connection) to the server. The 3D printer 702 can print the physical model 706 of the avatar 120. In some embodiments, a user's local computing device, via its web user interface 210 and/or mobile user interface 212, can access, send instructions to, and/or control the 3D printer 702. In some embodiments, a user can control the 3D printer 702 via its own local user interface. The physical model 706 can be received in any suitable manner, e.g., directly picked up by a user or another person going to the 3D printer 702, delivered to the user by another person or a delivery service, delivered to a recipient chosen by the user, etc. Based on the teachings disclosed herein, a user can create, modify, and/or compile one or more digital assets for 3D printing, without the user having a sophisticated knowledge base or expertise with using 3D software and without the user needing to use professional 3D software tools.

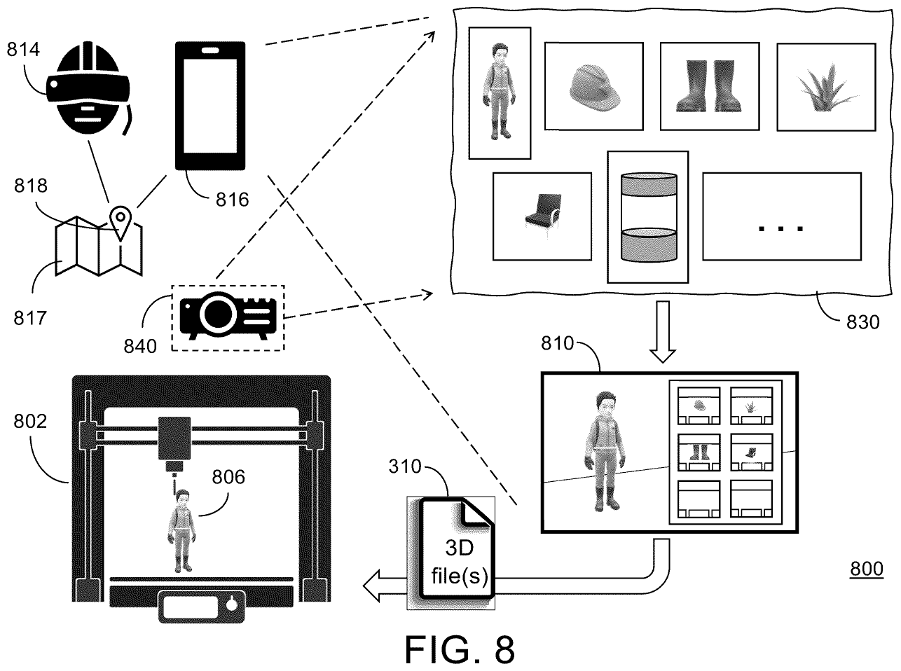

FIG. 8 illustrates an example system 800 where a user can encounter a geolocated event where a 3D asset compiler can be used with 3D printing. Due to the digital and online aspects of a 3D asset compiler, a user can encounter an augmented reality (AR) or mixed reality (MR) pop-up event, such as an AR or MR bazaar marketplace 830 where the user can select one or more digital assets available in the bazaar marketplace 830 and then 3D print the selected digital asset(s) onsite at a 3D printer machine or booth 802 at the pop-up bazaar location. The bazaar marketplace 830 may be located at or anchored to a geographical location in the real world, which may be accessed at that geographical location 818. An object or marker may be visible on a map program that recognizes the bazaar marketplace 830, such as through a web browser or a dedicated app. That object or marker may be visible through a user's UI (e.g., on the display of a smartphone, computer, HUD, headset, smart glasses, etc.) or physically scannable through a user's UI (e.g., via a camera of smartphone, computer, HUD, headset, smart glasses, etc.) of the user's local computing device running a map program that recognizes the bazaar marketplace 830, such as through a web browser or a dedicated app. The user can access the bazaar marketplace 830 by interacting with that object or marker on a map program, in AR (e.g., a link shown on or around the object or marker on a touchscreen), or in MR (e.g., picking up, grabbing, touching, or other gesture with the object or marker). In some embodiments, the bazaar marketplace 830 may be hosted on a server (e.g., on circuitry 220 or on other circuitry). In some embodiments, a user may have a digital ticket or some other identifier or characteristic that the server recognizes so as to permit the user's UI to access the bazaar marketplace 830 (e.g., to see and/or interact with the bazaar marketplace 830 via the user's UI). Some examples of the user's UI may be AR or MR headset 814 or smartphone 816.

The map program may be run by a server (e.g., on circuitry 220 or on other circuitry) hosting the bazaar marketplace 830. Map 817 may provide services in x and y coordinates, such as the cardinal directions of north, south, east, and west. Map 817 may obtain x and y coordinate data from GPS positioning data and/or available base map services.

Via a user's UI of the user's local computing device, the user can view and navigate the bazaar marketplace 830. The bazaar marketplace can be presented to the user in any format, such as a suspended AR or MR window of digital assets, an AR or MR overlay onto the user's local physical environment, a window on a physical display, etc. In some embodiments, the bazaar marketplace 830 can be presented to a user via laser projectors 840 that portray the bazaar marketplace 830 at the geographical location 818 at laser wavelengths that are outside the human visible spectrum but visible to imaging equipment (e.g., camera(s), optical sensor(s)) of the user's UI (e.g., AR or MR headset 814 or smartphone 816), so that the bazaar marketplace is visible through the user's UI but not visible to other humans lacking suitable imaging equipment (e.g., ordinary bystanders or pedestrians). Via the user's UI, the user can select one or more digital asset(s) available in the bazaar marketplace 830 for collecting or obtaining or purchasing. The user can import the selected digital asset(s) into a 3D asset compiler, as indicated by its graphical user interface 810, which may be available on the user's UI of the user's local computing device. Within the 3D asset compiler (which may be running on a server on circuitry 220), the user can combine together or compile together multiple digital assets together into a composed or compiled 3D model for outputting to a 3D printer or booth 802. The 3D asset compiler can output 3D file(s) 310, which can be obtained by the 3D printer or booth 802. Based on the output 3D file(s) 310, the 3D printer or booth 802 can 3D print a physical model 806 of the composed or compiled 3D model of the output 3D file(s). In some embodiments, a user's local computing device (e.g., AR or MR headset 814 or smartphone 816) can access, send instructions to, and/or control the 3D printer or booth 802. In some embodiments, a user can control the 3D printer or booth 802 via its own local user interface. In some embodiments of system 800, the 3D printer or booth 802 is located at or near the geographical location 818 where the bazaar marketplace 830 was accessed by the user, so the user can easily promptly directly pick up the physical model 806 in person. In some embodiments of system 800, the 3D printer or booth 802 is located away or far from the geographical location 818, so the physical model 806 can be directly picked up by the user or another person going to the 3D printer or booth 802, delivered to the user by another person or a delivery service, delivered to a recipient chosen by the user, etc.

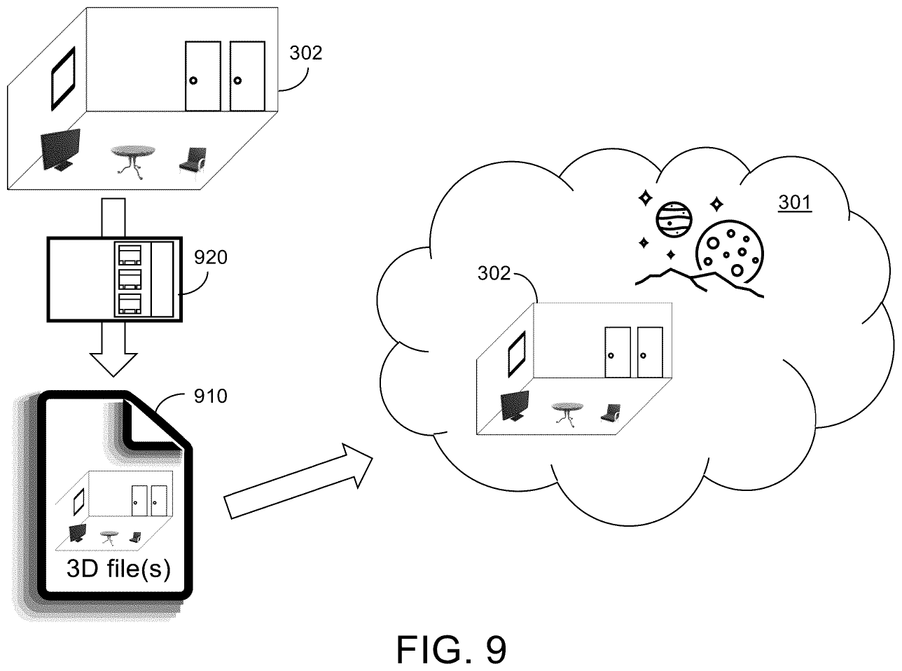

FIG. 9 illustrates an output 3D file from a 3D asset compiler and another use of the 3D file. The capabilities and functionalities of a 3D asset compiler are not limited to the examples above. A 3D asset compiler can have other user interface implementations different from the above example graphical user interfaces. A 3D asset compiler can output other digital assets different from the above example avatars, display cases, asset items, etc. For example, a user can apply the capabilities and functionalities of a 3D asset compiler to a digital place(s) 302. Instead of adding (or removing) asset items from an avatar or display case or bookshelf that visually fits within the physical boundaries of a screen of a display (e.g., a display screen of a web user interface 210 or a mobile user interface 212), a user can navigate through a digital place 302 (e.g., in a first-person point-of-view (POV), in a third-person POV with a camera view slightly behind an avatar) and, from within the digital place 302, the user can add (or remove, place, replace, move, rotate, flip, rearrange, etc.) digital assets (e.g., 2D, 3D), such as furniture, artwork, clothing, sculpture, plant, animal, video game weapon, armor, tool, avatar, etc. FIG. 9 shows an example digital place 302 including two doors, artwork on a wall, a TV, a table, and a chair. Via a user's GUI (e.g., 920 in FIG. 9) of the user's local computing device, the user can instruct a 3D asset compiler (e.g., running on a server on circuitry 220) to output the digital place 302, e.g., as composed or compiled of the included digital assets shown in FIG. 9, as a composed or compiled whole 3D model exported into a 3D file 910. In some embodiments, a 3D asset compiler converts the multiple digital assets (e.g., the digital place itself, two doors, artwork on a wall, a TV, a table, and a chair) into a single object that constitutes the 3D model in the 3D file 910. The 3D asset compiler can apply the techniques disclosed herein for exporting the 3D file 910 into various file types, e.g., GLB, GLTF, FBX, OBJ, etc. The 3D asset compiler can apply file optimization and/or compression techniques, e.g., as disclosed herein, when generating the 3D file 910. The 3D asset compiler can apply the 3D printing-related techniques, e.g., as disclosed herein, when generating the 3D file 910, such as a file type (e.g., an STL file, CAD file) that is compatible with 3D printing technology, and/or when using the 3D file 910, such as to print a real-life physical model of the digital place 302 via a 3D printer or booth.

An example use of a digital place 302, compiled or composed by a 3D asset compiler, may be as an importable digital place 302 into a video game world 301 in FIG. 9. The imported digital place 302 may be a custom room or a custom building in a video game having a sci-fi theme. The 3D asset compiler can output a 3D file 910 that has the file type of a first 3D video game engine. When the video game is also based on the same first 3D video game engine, the digital place 302 of that 3D file 910 can be compatibly imported into that video game and readily usable as a room or a building. In some embodiments, within the 3D asset compiler, the user interface may also be based on the same first 3D video game engine. In some embodiments, within the 3D asset compiler, the user interface may be based on a different second 3D video game engine, and the 3D asset compiler can export digital place 302 as an output 3D file 910 that has the file type of the first 3D video game engine. In some embodiments, within the 3D asset compiler, the user interface may be based on a 3D experience engine native to the 3D asset compiler, and the 3D asset compiler can export digital place 302 as an output 3D file 910 that has the file type of the first 3D video game engine. In some embodiments, the 3D asset compiler can output a 3D file 910 that has the output file type of an industry standard or a widely readable 3D file type, where the output file type is readable by a first 3D video game engine and/or a second 3D video game engine.

In some embodiments, a 3D asset compiler can convert a digital place 302 and its associated digital assets (e.g., two doors, artwork on a wall, a TV, a table, and a chair shown in FIG. 9) into a corresponding single 3D model. The 3D asset compiler can analyze the digital place 302 (and its associated digital assets) and then describe the analyzed content like a scene (e.g., certain lighting here, wood floors there, plants over there) into an output format or framework for a corresponding single 3D model. The analyzing may include one or more identifying steps that identify all the objects of the digital place 302 itself and its associated digital assets. The describing may include one or more packaging (or assembling) steps that package (or assemble) the identified objects into a corresponding single 3D model. The packaging (or assembling) may collapse or remove one or more internal layers or surfaces between overlapping objects so that only a single external layer or surface remains. The collapsing or removing of internal layer(s) or surface(s) underneath an external layer or surface may reduce the data size of the single 3D model of the digital place 302. The single 3D model may be a whole unitary baked object. The 3D asset compiler can apply file optimization and/or compression techniques, e.g., as disclosed herein, when generating the 3D file 910 of the digital place 302.

In some embodiments, a 3D asset compiler can convert an avatar 120 and its associated digital assets (e.g., as shown in FIG. 1) into a corresponding single 3D model. The 3D asset compiler can analyze the avatar 120 (and its associated digital assets). The analyzing may be based on a default or standard or base skeleton-like frame for avatars that is indexed by various classes, e.g., legs, arms, torso, feet, head, companion, tool, weapon, etc. Then, the 3D asset compiler can describe the analyzed content (e.g., these pants on the legs, this jacket on the arms and the torso, those boots on the feet, that helmet on the head, this specific weapon in a hand, that particular belt on the waist, this backpack on the back, etc.) into an output format or framework for a corresponding single 3D model. The analyzing may include one or more identifying steps that identify all the objects of the avatar 120 itself and its associated digital assets. The describing may include one or more packaging (or assembling) steps that package (or assemble) the identified objects into a corresponding single 3D model. The packaging (or assembling) may collapse or remove one or more internal layers or surfaces between overlapping objects so that only a single external layer or surface remains. The collapsing or removing of internal layer(s) or surface(s) underneath an external layer or surface may reduce the data size of the single 3D model of the output avatar 120 rigged with all of its digital assets or objects. The single 3D model may be a whole unitary baked object. The 3D asset compiler can apply file optimization and/or compression techniques, e.g., as disclosed herein, when generating the 3D file 310 of the avatar 120. In contrast with other techniques that change the appearance of an avatar on the basis of traits that are skins (e.g., 2D-patterned skin, 3D-overlaid skins), the 3D asset compiler can modify the appearance of the avatar 120 by adding (or removing) distinct actual 3D objects (e.g., from a 3D-object file).

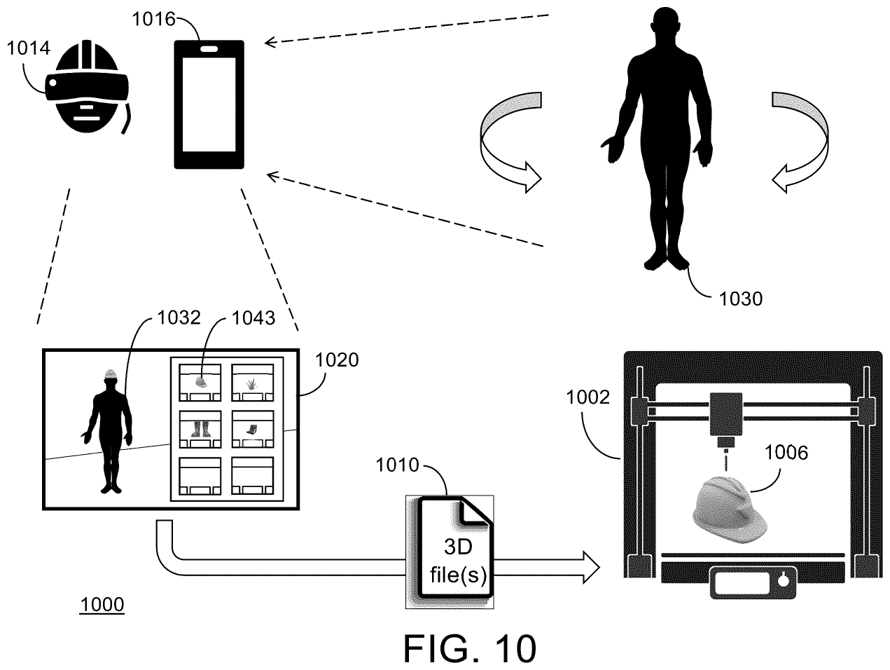

FIG. 10 illustrates an example system 1000 where a user can scan a physical object and use a 3D asset compiler with 3D printing to make objects based on that scanning. Via a user's UI of the user's local computing device, the user can view and scan a physical object 1030 (e.g., the user's own body, another human's body, a mannequin, etc.). For example, in some embodiments, a user's local computing device (e.g., an AR or MR headset 1014, a smartphone 1016, computer, HUD, smart glasses, etc.) can conduct one or more scan(s) of the physical object 1030 with any suitable scanning equipment (e.g., one or more camera(s), one or more optical sensor(s), and/or one or more detector(s), etc.). The user can capture one or more images of multiple views. The user can move around the physical object 1030 to capture one or more views, such as complementary views that can be “stitched” together. The physical object 1030 can be moved and/or reoriented to capture one or more views. Based on the one or more scan(s) of the physical object 1030, the 3D asset compiler can generate a corresponding (in part or in whole) 3D model 1032 as a digital asset to be presented to the user, e.g., by a displayed graphical user interface 1020 of a AR or MR headset 1014 or smartphone 1016. Via the GUI, the user can select one or more digital asset(s) available in (e.g., previously imported) or available to (e.g., importable) the 3D asset compiler, e.g., a helmet 1043, boots, a plant, or a chair shown in FIG. 10. Within the 3D asset compiler (which may be running on a server on circuitry 220), the user can select a digital asset, such as the helmet 1043, to try on the 3D model 1032 corresponding to the physical object 1030, where trying the helmet 1044 on the 3D model 1032 is similar or equivalent to composing or compiling multiple digital assets into a single 3D object as described above. The user can modify the selected digital asset (e.g., modify any or all of the size, the color, the style, the shape, etc.) relative to the 3D model 1032. The user can instruct the 3D asset compiler to output the selected digital asset, such as the helmet 1043, in a 3D file(s) 1010 to be transmitted to manufacturing or production equipment (e.g., a 3D printer or booth 1002, a factory, a smart or programmable sewing machine, etc.). The 3D asset compiler can output 3D file(s) 1010, which can be provided to manufacturing or production equipment, such as 3D printer or booth 1002. Based on the output 3D file(s) 1010, the 3D printer or booth 1002 can 3D print a physical model or replica 1006 of the selected digital asset of the output 3D file(s) in a size, color, style, etc. corresponding to the selection(s) indicated or modification(s) made by the user. In some embodiments, the 3D model 1032 can include dimensional data that corresponds to measurements of the physical object 1030 that was scanned to create the 3D model 1032. In such instances, the output 3D file(s) 1010 provided to the 3D printer or booth 1002 may print a physical model or replica 1006 (e.g., of a helmet 1043) that fits the original physical object 1030.

In some embodiments, a user's local computing device (e.g., AR or MR headset 1014 or smartphone 1016) can access, send instructions to, and/or control the 3D printer or booth 1002. In some embodiments, a user can control the 3D printer or booth 1002 via its own local user interface. In some embodiments of system 1000, the 3D printer or booth 1002 is located at or near the geographical location of the user's local computing device, so the user can directly obtain the 3D-printed physical model or replica 1006 in person. In some embodiments of system 1000, the 3D printer or booth 1002 is located away or far from the geographical location of the user's local computing device, so the physical model or replica 1006 can be directly picked up by the (traveling) user or another person visiting the 3D printer or booth 1002, delivered to the user, delivered to a recipient chosen by the user, etc.

The physical model or replica 1006 of helmet 1043 may fit on the physical object 1030 in real life similarly to how the helmet 1043 fit on the 3D model 1032 in the 3D asset compiler. The 3D asset compiler can select multiple digital assets (e.g., different parts of a suit of armor, different parts of an American football suit, etc.), compiling some or all together into a composed or compiled 3D object (e.g., the suit of armor, the outfit, etc.) for outputting to a 3D printer or booth 1002. The 3D printer or booth 1002 may include painting and/or coloring capabilities that can paint and/or color the physical model or replica 1043 based on selected visual appearance(s) of the selected digital asset(s) in the output 3D file(s) 1010.

In some embodiments, a 3D asset compiler can be configured to create new digital assets (e.g., via AI and/or ML tools(s)), in addition to or instead of importing pre-existing digital assets, for any or all of the embodiments disclosed herein. For example, a 3D asset compiler can receive input text prompts and/or 2D images to its AI functionality to create a new helmet asset for equipping an avatar 120 or fitting on a 3D model 1032, instead of importing a helmet 143 or a helmet 1043. The AI-generated helmet (e.g., as part of a composed output avatar 120, fitted onto 3D model 1032) can then be manufactured or produced, e.g., 3D printed, by any of the 3D-print techniques disclosed herein.

For another example, a user can create or find a 2D image of a metal armor plate, and then input text prompts and that 2D image to a 3D asset compiler's AI functionality to create a 3D metal armor chest plate having the visual appearance or semblance of the 2D image to decorate, dress, equip, or outfit an avatar 120. For yet another example, a user can scan himself/herself to create a user model, and associate with the user model actual user size measurements and proportions, obtained similar to how a human tailor might take measurements of the user. The user can then create or find, for example, a shirt design sized based on the user model, and then input text prompts and that shirt design to a 3D asset compiler's AI functionality to create a 3D shirt asset having the visual appearance or semblance of the shirt design. Based on the scan(s) and/or obtained size measurements and proportions, the created shirt (or other clothing) fits the user model. The corresponding output 3D file(s) may be transmitted to a smart or programmable sewing machine or a factory capable of manufacturing a physical shirt in fabric(s), based on the 3D shirt asset.

In some embodiments, a 3D asset compiler can output an output 3D file(s) that is not limited to data of a 3D model, but may include a specific design, pattern, or specific instructions describing operations to produce a physical product, e.g., by 3D printing, by clothing design for a machine or factory that produces clothing, etc. Also, the output 3D file can include a design or instructions that dictate the production of a multi-component 3D object, e.g., by 3D printing multiple interacting or complementary components, in parallel, of a whole multi-component 3D object. Additionally, the output 3D file can include a design(s) or instructions for handling multiple kinds of material of a multi-material 3D object, e.g., biomaterial for skin-type of component, hair material for a hair-type of component, rubber for boots, etc. The design(s) or instructions may include unique identifiers for certain materials, a certain sequence of actions, etc. The design(s) or instructions may include assigned parameters, which may be customizable and recognizable by production hardware. The output 3D file may be compatible with 3D printing technology (e.g., an STL file type, a CAD file type, etc.) or fabric manufacturing, and may further include a design or instructions such as a scripting language.

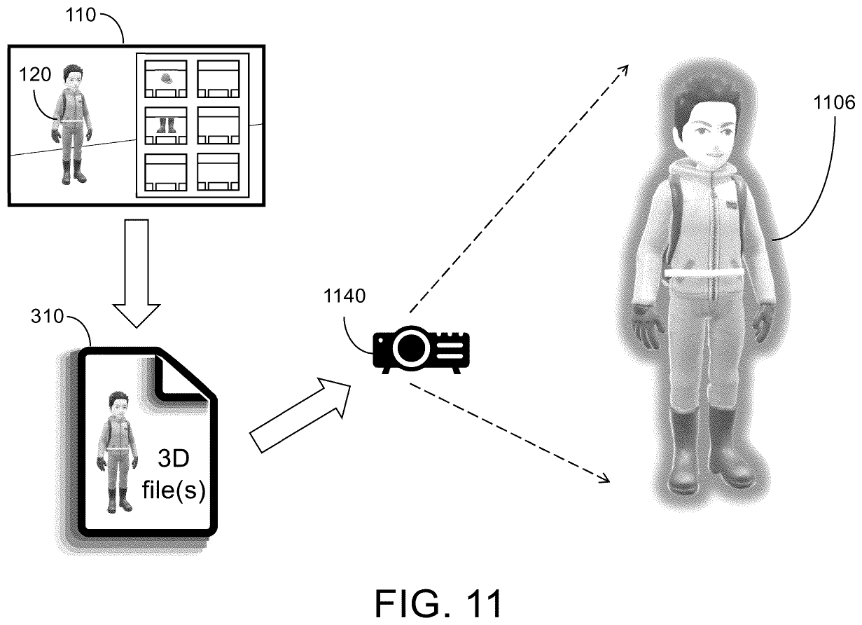

FIG. 11 illustrates an output 3D file 310 from a 3D asset compiler where the 3D file 310 is usable for 3D hologram projection. A 3D asset compiler can export a 3D digital asset (e.g., composed of one or more digital assets) into a file type that is compatible with 3D hologram projection, e.g., image file types, and/or video file types. A 3D asset compiler, indicated by the graphical user interface 110, may be configured to compile or combine together multiple 3D asset items with an avatar 120 in real-time to create custom 3D file(s) 310 and export those files, where the output 3D file(s) are compatible with 3D printer(s), e.g., image file types, video file types. The 3D asset compiler may provide a 3D file 310 to a 3D hologram projector (e.g., laser projector(s)) 1140 by any suitable manner, e.g., wired connection by known or wired communication protocols, wireless connection and wireless communication protocol, etc. Based on the 3D file 310 in a 3D-hologram file format (e.g., image file types, video file types), the 3D hologram projector 1140 can project a holographic projection of the avatar 120.

In some embodiments, a user's local computing device, via its web user interface 210 and/or mobile user interface 212, can access a 3D asset compiler running on a server (on circuitry 220). Based on user instructions, the 3D asset compiler can output a 3D file 310 to a 3D hologram projector 1140 that is connected (e.g., by wired or wireless connection) to the server. The 3D hologram projector 1140 can project the holographic projection 1106 of the avatar 120. In some embodiments, a user's local computing device, via its web user interface 210 and/or mobile user interface 212, can access, send instructions to, and/or control the 3D hologram projector 1140. In some embodiments, a user can control the 3D hologram projector 1140 via its own local user interface. Based on the present disclosure, the presently disclosed 3D asset compiler can be utilized to create, modify, and/or compile one or more digital assets for 3D hologram projection, without the user having a sophisticated knowledge base or expertise with using 3D software and without the user needing to use professional 3D software tools.

A 3D asset compiler can incorporate any and all of the various teachings of the different exemplary use cases disclosed herein. With a variety of available use cases, a user can have the ability to select multiple output use cases that each have quite different output goals from another use case. For example, the 3D asset compiler can output a composed 3D avatar for use in the digital environment of a video game. In some embodiments, the same 3D asset compiler can may provide 3D asset files usable by 3D printing or other production equipment to output a physical object (e.g., a statue, clothing, costumes, components for a prototype car, etc.) for a real-life environment. The same 3D asset compiler can generate 3D asset files useable b y3D hologram projection equipment to output a holographic projection of the composed 3D avatar or other digital assets (e.g., a statue, clothing, costumes, components for a prototype car, etc.), projected into a real-life environment.

Based on the target use case, the 3D asset compiler can maintain the properties that are suitable or optimal for that target use case, e.g., identifying data and/or aspects that are important to keep. In the example case of 3D printing a digital statue for a 3D printer that only prints in gray print material, the digital statue's color(s) may be visible in the 3D asset compiler, but the corresponding output 3D file may omit color data and/or aspects of the digital statue when sent to the gray-only 3D printer. A user may apply color (e.g., paint) to the single-color (e.g., gray) 3D-printed statue later in a different process. In contrast, in the example case of a composed 3D avatar for use in a video game, a user of the 3D asset compiler may want the output 3D file to keep data and/or aspects on clothing/equipment rigging corresponding to the uncomposed 3D avatar, so as to be able to remove or replace clothing/equipment on the composed 3D avatar when obtaining new clothing/equipment in the video game. In further contrast, in the example case of a holographic projection of a composed 3D avatar into a real-life environment, a user of the 3D asset compiler may omit collider parameters or parameter values from the output 3D file, as the holographic projection is emissive light with no physical matter boundaries.

In some embodiments, an avatar 120 may include a modular design for use with a 3D asset compiler. Such an avatar 120 may be divisible into a variety of component parts, so that a user can design the avatar 120 according to a target style or preference or goal. The avatar 120 may be a child class of a Character class, which may have a collection of components for some or all body parts and pieces of equipment (e.g., weapons, tools, etc.) The modular design may include a base body Skeleton (or frame), and body part Components may attach or bind to the base Skeleton. Attached/bound body part Components can be movable and/or animated based on the base Skeleton's movements and/or animations. Equipment Components may have their own respective, independent equipment Skeletons, and the equipment Components may have respective visual appearance skins over the Skeletons. The equipment Components may connect to specific sockets of the base body Skeleton and may in some embodiments inherit movement and relative position information from the base body Skeleton. The 3D asset compiler can combine or compile together the various Components in order to reach a composed or compiled avatar 120.

The Components may be digital assets. Each digital asset may have a specific, respective data table or dataset. Body part Components may include, but are not limited to: Headgear, Torso, Upper Arms, Hands, Legs, Feet, etc. Equipment Components may include, but are likewise not limited to: weapons (e.g., pistol, rifle), tools, etc. The modular design may include certain body part Components having different respective designs by gender (e.g., male, female). Each data table or dataset may include a default assigned object per body part type and per gender type, but a null (nothing) value for a piece of equipment. For the purpose of runtime data storage, according to the modular design, a Player Controller may have a Cosmetics Component, which may store data of the avatar 120, related NFT token data, and references to Cosmetic Part Objects (which may be a special class to store data on the client side for one or more body part/equipment Components). Every Cosmetic Part Object may store an Asset Type and relevant Element data. Assets may be put on the avatar on the back-end side, each single one may have a unique ID; there may be only a single Element per Asset Type for every avatar, or none if Asset on the Character is default.

The following process is a non-limiting example for launching an avatar generation user interface. The process may abort if a step fails.

1. When a Player Controller possesses a Character at the start of a session, a Client may initialize a Cosmetics Component into its default state, initializing Cosmetic Part Objects to their Default state.

2. The Client may send a request to obtain an avatar. The server or a local avatar data server daemon instantiation may respond with avatar data. The avatar data may be associated with the Cosmetics Component.

3. The Cosmetics Component may read Elements inside the avatar data and modify its Cosmetic Part Objects with relevant data from the Elements. The Cosmetic Part Objects may modify referenced Components of the Character, changing their models to those referenced in the Element data.

4. The Client may send a request to get NFT tokens available to the user. The back-end may respond with NFT token data. The NFT token data may be put into the Cosmetics Component.

5. The NFT Token Data may be sorted per Asset Type. Unsupported types may be discarded and not stored.

6. The NFT Token Data may be sorted per existence of a corresponding asset in the data tables or datasets on the Client. Assets not represented on the Client (not preloaded) may be discarded and not stored.

7. In case the avatar was not generated, the Client may launch the avatar generation user interface. If the avatar was generated, the Client may launch a customization user interface if the gender type allows that. The user interface may be populated with relevant representations of Assets split by Asset Types, taken from the sorted NFT token data.

8. The user can change the appearance of this or that part, switching assets and even adding a tint to highlighted elements.

9. After pushing a Finish Customization button, the Client may send a http DELETE Element by ID request for all Elements that were previously on the avatar.

10. The Cosmetic Component may read the current state of Cosmetic Objects. Based on results of that, the Client may send a POST Element request for every Element on the Client side, which Asset is not Default, thus storing the results of the avatar generation on the back-end. For integrity, even if the same asset was assigned before the customization and after, the “before” Element that held this Asset is still deleted, and a new Element with the same Asset created. Also, if the latter request was successful, the avatar may be marked as Generated, thus preventing a double-generation situation.

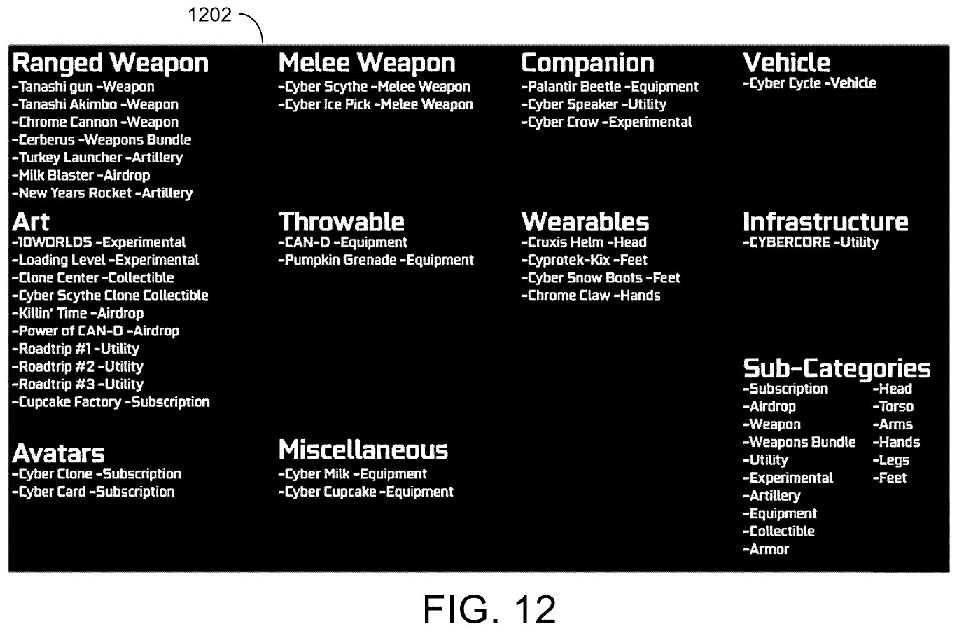

All Asset models that can be assigned to a specific part may be built-in into the Client or available via runtime uploading. FIG. 12 illustrates an example of trait sorting for a modular design of an avatar for use with a 3D asset compiler.

In some embodiments, a 3D asset compiler can handle user-made digital assets. In contrast to digital environments that limit digital assets to those provided and built-in by the developers of those digital environments, a 3D asset compiler can provide or be part of a solution for users to directly upload their 3D models, e.g., static or animated, right into a scene of a digital environment at runtime. Such models may be stored and loaded every time a user enters the digital environment, just like built-in assets. The following process is a non-limiting example workflow:

1. A user may choose to place a special Custom Asset copy into a scene (e.g., a pedestal), choosing its placement the same way as with other asset types.

2. A Client may send a request to register a new Asset on the back-end. The back-end may respond with the posted data of a newly created Asset.

3. The Client may render the instance of the Custom Asset (e.g., the pedestal), filling its client-side Asset Data retrieved from the back-end.

4. The user may interact with this instance to bring out an interaction user interface, calling an operating system file explorer from it and choosing a GLB file for upload.

5. The selected file may be parsed and sent to the back-end.

6. The back-end may receive the file and send back a Uniform Resource Locator (URL) path to the created file.

7. The Client may write the received URL in the client-side Asset Data of the Copy, then may sends a request with an updated Asset Data of the Copy (which now has a filled field for URL path to download a GLB). The back-end may respond with the same content as the request.

8. The Client may commences an async download of the GLB, using the URL field from the previous back-end response.

9. The GLB may be parsed into an Unreal-class asset Scene keeping hierarchy of embedded models. Models may be parsed as Unreal Engine class: Static Meshes if no animation or Skeletal Meshes if with animation. Animations, skeletons, etc. may also be parsed into relevant Unreal classes.

10. The Scene may be rendered into the Level onto the pedestal.

The user can interact with a user-made asset similar to built-in assets, being able to change its location, rotation, scale, hide the pedestal, add color tint, etc.

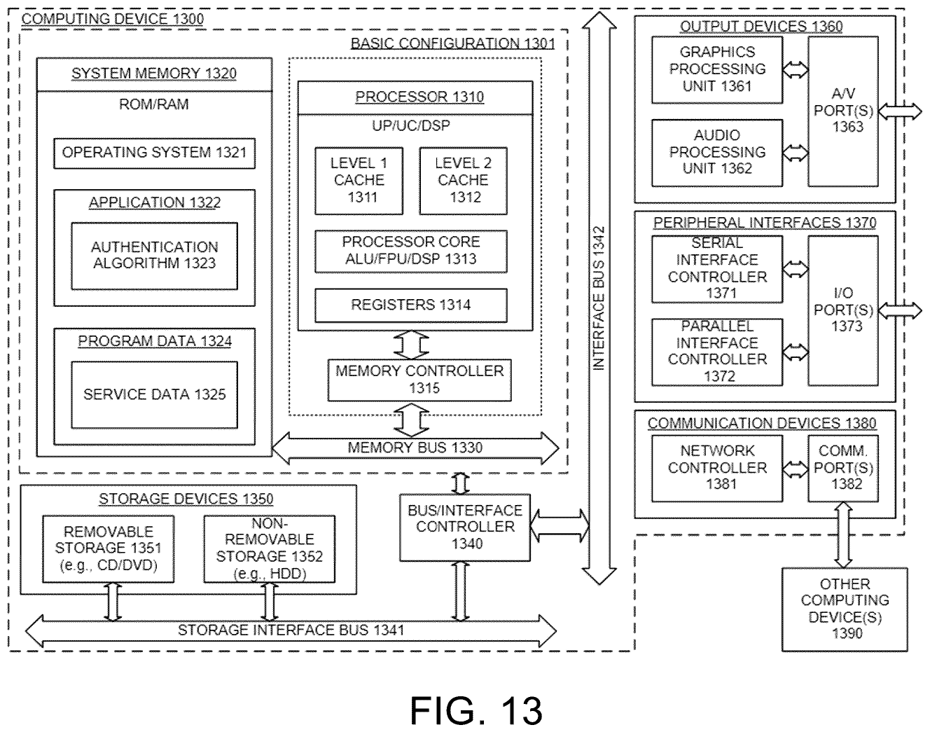

FIG. 13 is a circuit diagram of one aspect of a computing device 1300 that may work in conjunction with the elements of the present disclosure. In a very basic configuration of computing device 1300, the computing device 1300 typically includes one or more processors 1310 and a system memory 1320. A memory bus 1330 can be used for communications between the processor 1310 and the system memory 1320.

Depending on the desired configuration, the one or more processor 1310 of computing device 1300 can be of any type including but not limited to a microprocessor, a microcontroller, a digital signal processor, or any combination thereof. Processor 1310 can include one or more levels of caching, such as a level one cache 1311 and a level two cache 1312, a processor core 1313, and registers 1314. The processor core 1313 can include an arithmetic logic unit (ALU), a floating point unit (FPU), a digital signal processing core (DSP Core), or any combination thereof. A memory controller 1315 can also be used with the processor 1310, or in some implementations the memory controller 1315 can be an internal part of the processor 1310.

Depending on the desired configuration, the system memory 1320 can be of any type including but not limited to volatile memory (such as RAM), non-volatile memory (such as ROM, flash memory, etc.) or any combination thereof. System memory 1320 typically includes an operating system 1321, one or more applications 1322, and program data 1324. Application 1322 includes an authentication algorithm 1323. Program Data 1324 includes service data 1325.

Computing device 1300 can have additional features or functionality, and additional interfaces to facilitate communications between the basic configuration 1301 and any required devices and interfaces. For example, a bus/interface controller 1340 can be used to facilitate communications between the basic configuration 1301 and one or more data storage devices 1350 via a storage interface bus 1341. The data storage devices 1350 can be removable storage devices 1351, non-removable storage devices 1352, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1320, removable storage 1351 and non-removable storage 1352 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1300. Any such computer storage media can be part of the computing device 1300.

Computing device 1300 can also include an interface bus 1342 for facilitating communication from various interface devices (e.g., output interfaces, peripheral interfaces, communication interfaces, etc.) to the basic configuration 1301 via the bus/interface controller 1340. Example output devices 1360 include a graphics processing unit 1361 and an audio processing unit 1362, which can be configured to communicate to various external devices such as a display or speakers via one or more A/V ports 1363. Example peripheral interfaces 1370 include a serial interface controller 1371 or a parallel interface controller 1372, which can be configured to communicate with external devices such as input devices (e.g., keyboard, mouse, pen, voice input device, touch input device, etc.) or other peripheral devices (e.g., printer, scanner, etc.) via one or more I/O ports 1373. An example communication device 1380 includes a network controller 1381, which can be arranged to facilitate communications with one or more other computing devices 1390 over a network communication via one or more communication ports 1382. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

It should be noted that the circuitry 220, web user interface 210, mobile user interface 212, and/or electronic devices of distributed ledger network 240 in FIG. 2 may work in conjunction with the teachings disclosed by computing device 1300. Web user interface 210 may be part of a computing device that is comprised directly of elements shown in computing device 1300. Mobile user interface 212 may be part of a computing device that is comprised directly of elements shown in computing device 1300. An electronic device of distributed ledger network 240 may be a computing device that is comprised directly of elements shown in computing device 1300. Circuitry 220 may be a computing device that is comprised directly of elements shown in computing device 1300 and in combination with the teachings of FIG. 2; for example, one or more GPUs 228 may be included, not among output devices 1360, but with processor 1310 and system memory 1320 on memory bus 1330.

Computing device 1300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1300 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

What is claimed is:

1. A system comprising:
circuitry configured for:
hosting or running a three-dimensional (3D) asset compiler coded to present a graphical user interface (GUI) on a display of a user interface, wherein:
functionality of the 3D asset compiler is accessible via the GUI to be displayed on the display of the user interface, and
the functionality of the 3D asset compiler includes:
presenting a plurality of 3D digital assets to be displayed on the display of the user interface, the presented plurality of 3D digital assets accessible to be selected by a user via the GUI, and
compiling or combining together two or more 3D digital assets selected from among the presented plurality of 3D digital assets, the two or more 3D digital assets selected by the user via the GUI into a compiled or combined 3D object; and
non-transitory computer-readable storage configured for storing the 3D object when compiled or combined together from the selected two or more 3D digital assets, wherein the stored 3D object is to be rendered for display on the display of the user interface.

2. The system of claim 1, wherein:
the circuitry is further configured for:
importing the plurality of 3D digital assets to be presented by the 3D asset compiler; and
outputting an output 3D file comprising at least part of the 3D object; and
the non-transitory computer-readable storage configured for storing the imported plurality of 3D digital assets to be presented by the 3D asset compiler and for storing the output 3D file comprising the at least part of the 3D object.

3. The system of claim 2, wherein:
the imported plurality of 3D digital assets to be presented by the 3D asset compiler are working copy files or datasets of original copy files or datasets of the plurality of 3D digital assets, and
the output 3D file comprises at least one working copy file or dataset of at least part of the 3D object.

4. The system of claim 1, wherein:
the circuitry is further configured for:
generating an output 3D file comprising the 3D object, wherein the generating comprises performing optimization or compression so that the output 3D file is smaller in size than a total sum of the 3D digital assets selected to be compiled or combined into the 3D object; and
the non-transitory computer-readable storage configured for storing the output 3D file comprising the 3D object.

5. The system of claim 1, wherein:
the circuitry is further configured for:
receiving an input text prompt or an input image for use by an artificial intelligence (AI) or machine learning (ML) function; and
generating at least one of the plurality of 3D digital assets to be presented by the 3D asset compiler, wherein the generating comprises performing the artificial intelligence (AI) or machine learning (ML) function based on the input text prompt or the input image; and
the non-transitory computer-readable storage configured for storing the at least one generated 3D digital asset.

6. The system of claim 1, wherein:
the circuitry is further configured for:
implementing an Application Programming Interface (API) accessible by a 3D experience platform;
receiving one or more API calls from the 3D experience platform, calling for the 3D object to be conveyed to the 3D experience platform; and
conveying the 3D object to the 3D experience platform.

7. The system of claim 1:
the circuitry is further configured for:
outputting an output 3D file comprising at least part of the 3D object, the output 3D file compatible or belonging to a 3D-printing file type or file format; and
sending instructions to a 3D printer to 3D-print the at least part of the 3D object based on the output 3D file; and
the non-transitory computer-readable storage configured for storing the output 3D file comprising at least part of the 3D object.

8. The system of claim 1, wherein:
the circuitry is further configured for:
receiving one or more scans of a physical object;
generating, based on the one or more scans, a 3D model as one of the plurality of 3D digital assets to be presented by the 3D asset compiler, the 3D model to be compiled or combined together with another 3D digital asset selected from among the presented plurality of 3D digital assets, the another 3D digital asset selected by the user via the GUI for inclusion in the compiled or combined 3D object;
outputting an output 3D file comprising the another 3D digital asset, the output 3D file comprising a design or instructions for manufacturing the another 3D digital asset into a physical product; and
sending instructions to a fabrication machine or facility to manufacture the another 3D digital asset into the physical product based on the output 3D file; and
the non-transitory computer-readable storage configured for storing the output 3D file comprising the design or instructions for manufacturing the another 3D digital asset into the physical product.

9. The system of claim 8, wherein:
the physical object is a human body,
the one or more scans of the physical object comprise representations of one or more body parts of the physical object,
the 3D model generated based on the one or more scans has one or more actual size measurements or proportions of the scanned human body, and
the physical product comprises one or more pieces of clothing wearable by the physical object and based on the one or more actual size measurements or proportions of the scanned human body.

10. The system of claim 1, wherein:
the circuitry is further configured for:
outputting an output 3D file comprising at least part of the 3D object, the output 3D file comprising a file type that is compatible with 3D hologram projection; and
sending instructions to a 3D hologram projector to project the at least part of the 3D object as a holographic projection based on the output 3D file; and
the non-transitory computer-readable storage configured for storing the output 3D file comprising at least part of the 3D object.

11. A non-transitory computer-readable medium storing instructions, such that when the instructions are executed by one or more processors, the one or more processors are configured to perform a method comprising:
hosting or running a three-dimensional (3D) asset compiler coded to present a graphical user interface (GUI) on a display of a user interface, wherein:
functionality of the 3D asset compiler is accessible via the GUI to be displayed on the display of the user interface, and
the functionality of the 3D asset compiler includes:
presenting a plurality of 3D digital assets to be displayed on the display of the user interface, the presented plurality of 3D digital assets accessible to be selected by a user via the GUI, and
compiling or combining together two or more 3D digital assets selected from among the presented plurality of 3D digital assets, the two or more 3D digital assets selected by the user via the GUI into a compiled or combined 3D object,
wherein a non-transitory computer-readable storage stores the 3D object when compiled or combined together from the selected two or more 3D digital assets, wherein the stored 3D object is to be rendered for display on the display of the user interface.

12. The non-transitory computer-readable medium of claim 11, wherein the method further comprises:
importing the plurality of 3D digital assets to be presented by the 3D asset compiler; and
outputting an output 3D file comprising at least part of the 3D object,
wherein the non-transitory computer-readable storage stores the imported plurality of 3D digital assets to be presented by the 3D asset compiler and stores the output 3D file comprising the at least part of the 3D object.

13. The non-transitory computer-readable medium of claim 12, wherein:
the imported plurality of 3D digital assets to be presented by the 3D asset compiler are working copy files or datasets of original copy files or datasets of the plurality of 3D digital assets, and
the output 3D file comprises at least one working copy file or dataset of at least part of the 3D object.

14. The non-transitory computer-readable medium of claim 11, wherein the method further comprises:
generating an output 3D file comprising the 3D object, wherein the generating comprises performing optimization or compression so that the output 3D file is smaller in size than a total sum of the 3D digital assets selected to be compiled or combined into the 3D object,
wherein the non-transitory computer-readable storage stores the output 3D file comprising the 3D object.

15. The non-transitory computer-readable medium of claim 11, wherein the method further comprises:
receiving an input text prompt or an input image for use by an artificial intelligence (AI) or machine learning (ML) function; and
generating at least one of the plurality of 3D digital assets to be presented by the 3D asset compiler, wherein the generating comprises performing the artificial intelligence (AI) or machine learning (ML) function based on the input text prompt or the input image,
wherein the non-transitory computer-readable storage stores the at least one generated 3D digital asset.

16. The non-transitory computer-readable medium of claim 11, wherein the method further comprises:
implementing an Application Programming Interface (API) accessible by a 3D experience platform;
receiving one or more API calls from the 3D experience platform, calling for the 3D object to be conveyed to the 3D experience platform; and
conveying the 3D object to the 3D experience platform.

17. The non-transitory computer-readable medium of claim 11, wherein the method further comprises:
outputting an output 3D file comprising at least part of the 3D object, the output 3D file compatible or belonging to a 3D-printing file type or file format; and
sending instructions to a 3D printer to 3D-print the at least part of the 3D object based on the output 3D file,
wherein the non-transitory computer-readable storage stores the output 3D file comprising at least part of the 3D object.

18. The non-transitory computer-readable medium of claim 11, wherein the method further comprises:
receiving one or more scans of a physical object;
generating, based on the one or more scans, a 3D model as one of the plurality of 3D digital assets to be presented by the 3D asset compiler, the 3D model to be compiled or combined together with another 3D digital asset selected from among the presented plurality of 3D digital assets, the another 3D digital asset selected by the user via the GUI for inclusion in a compiled or combined 3D object;
outputting an output 3D file comprising the another 3D digital asset, the output 3D file comprising a design or instructions for manufacturing the another 3D digital asset into a physical product; and
sending instructions to a fabrication machine or facility to manufacture the another 3D digital asset into the physical product based on the output 3D file,
wherein the non-transitory computer-readable storage stores the output 3D file comprising the design or instructions for manufacturing the another 3D digital asset into the physical product.

19. The non-transitory computer-readable medium of claim 18, wherein:
the physical object is a human body,
the one or more scans of the physical object comprise representations of one or more body parts of the physical object,
the 3D model generated based on the one or more scans has one or more actual size measurements or proportions of the scanned human body, and
the physical product comprises one or more pieces of clothing wearable by the physical object and based on the one or more actual size measurements or proportions of the scanned human body.

20. The non-transitory computer-readable medium of claim 11, wherein the method further comprises:
outputting an output 3D file comprising at least part of the 3D object, the output 3D file comprising a file type that is compatible with 3D hologram projection; and
sending instructions to a 3D hologram projector to project the at least part of the 3D object as a holographic projection based on the output 3D file,
wherein the non-transitory computer-readable storage for storing the output 3D file comprising at least part of the 3D object.
